(19) United States
(12) Patent Application Publication
(10) Pub. No.: US 2026/0023410 A1
(43) Pub. Date: Jan. 22, 2026

(54) Foldable Display Module and Foldable Display Apparatus

(71) Applicants: MIANYANG BOE OPTOELECTRONICS TECHNOLOGY CO., LTD., Sichuan (CN); BOE TECHNOLOGY GROUP CO., LTD., Chaoyang District, Beijing (CN)

(72) Inventors: Jinxu Cheng, Beijing (CN); Feng Zhan, Beijing (CN); Xu Lu, Beijing (CN); An Fu, Beijing (CN); Junwei Xie, Beijing (CN); Jia Zeng, Beijing (CN); Zijian Wang, Beijing (CN)

(21) Appl. No.: 18/869,740

(22) PCT Filed: Aug. 13, 2024
(86) PCT No.: PCT/CN2024/111862

§ 371 Date: Nov. 26, 2024

(30) Foreign Application Priority Data
Sep. 27, 2023 (CN) 202311268613.9

(51) Int. Cl. G06F 1/16; G02B 1/14

(52) U.S. Cl. CPC G06F 1/1652; G02B 1/14; G06F 1/1641; G06F 1/1656

(57) ABSTRACT

A foldable display module includes a support layer, an adhesive layer, a flexible display panel and a protective layer. The flexible display panel is located on the adhesive layer. The flexible display panel includes first display portions and at least one second display portion. The first display portions are sequentially arranged in a first direction. A second display portion is located between two adjacent first display portions. The second display portion is bendable, and a bending axis is along a second direction. The second display portion has a non-adhesive region and adhesive regions located on two opposite sides of the non-adhesive region in the second direction. The adhesive layer includes first adhesive portions and second adhesive portions. A first adhesive portion is disposed between a first display portion and the support layer. At least one second adhesive portion is disposed in an adhesive region.

### CROSS-REFERENCE TO RELATED APPLICATIONS

This application is United States national phase of International Patent Application No. PCT/CN2024/111862, filed Aug. 13, 2024, and claims priority to Chinese Patent Application No. 202311268613.9, filed Sep. 27, 2023, the disclosures of which are hereby incorporated by reference in their entireties.

### BACKGROUND OF THE INVENTION

### Field of the Invention

The present disclosure relates to the field of display technologies, and in particular, to a foldable display module and a foldable display apparatus.

### Description of Related Art

Display apparatuses have been used in all aspects of life. The display apparatuses include foldable display apparatuses, which can be switched between an unfolded state and a folded state. The foldable display apparatuses in the unfolded state have large display areas, which may improve the viewing effect. The foldable display apparatuses in the folded state have small volumes, which can be convenient for users to carry.

### SUMMARY OF THE INVENTION

In an aspect, a foldable display module is provided. The foldable display module includes a support layer, an adhesive layer, a flexible display panel and a protective layer. The adhesive layer is located on the support layer. The flexible display panel is located on the adhesive layer. The flexible display panel includes a plurality of first display portions and at least one second display portion, the plurality of first display portions are sequentially arranged in a first direction, and a second display portion is located between two adjacent first display portions; the second display portion is bendable, and a bending axis is along a second direction; the second display portion has a non-adhesive region and adhesive regions that are located on two opposite sides of the non-adhesive region in the second direction, the first direction being perpendicular to the second direction. The protective layer is located on the flexible display panel. The adhesive layer includes a plurality of first adhesive portions and a plurality of second adhesive portions, a first adhesive portion is disposed between a first display portion and the support layer, and at least one second adhesive portion is disposed in an adhesive region.

In some embodiments, the second adhesive portion is in a shape of a strip; and in the first direction, the second adhesive portion is connected to two first adhesive portions located on two opposite sides of the second adhesive portion.

In some embodiments, a border of the second adhesive portion close to the non-adhesive region is curved, and protrudes toward a direction close to the non-adhesive region.

In some embodiments, a connection position between the second adhesive portion and a first adhesive portion is chamfered.

In some embodiments, the second adhesive portion includes a connection portion and a plurality of protruding portions. In the first direction, the connection portion is connected to two first adhesive portions located on two opposite sides of the connection portion. The connection portion is connected to the plurality of protruding portions. The plurality of protruding portions are disposed on a side of the connection portion close to the non-adhesive region, and the plurality of protruding portions are arranged at intervals in the first direction.

In some embodiments, in the first direction, lengths of the plurality of protruding portions first increase and then decrease; and a length of a protruding portion is a maximum size of the protruding portion in the second direction.

In some embodiments, a connection position between a protruding portion and the connection portion is chamfered.

In some embodiments, an end of a protruding portion away from the connection portion has a rounded corner.

In some embodiments, in the second direction, a maximum size of the second adhesive portion is in a range of 5 mm to 10 mm.

In some embodiments, the non-adhesive region has a center line along the first direction. Second adhesive portions in two adhesive regions are symmetrically arranged about the center line.

In some embodiments, the support layer is provided therein with a plurality of through holes, and orthogonal projections of the plurality of through holes on the second display portion are located within the non-adhesive region.

In some embodiments, the first adhesive portions and the second adhesive portion constitute a one-piece structure.

In some embodiments, the protective layer includes a first substrate layer and a first hard coating layer. The first substrate layer is located on the flexible display panel. The first hard coating layer is disposed on a side of the first substrate layer away from the flexible display panel. The foldable display module further includes at least one second hard coating layer disposed between the first substrate layer and the flexible display panel.

In some embodiments, the at least one second hard coating layer includes one second hard coating layer, and the foldable display module further includes a second substrate layer disposed between the first substrate layer and the second hard coating layer.

In some embodiments, a thickness of the second substrate layer is less than a thickness of the first substrate layer.

In some embodiments, the at least one second hard coating layer includes a plurality of second hard coating layers, and the foldable display module further includes: a third substrate layer disposed between two adjacent second hard coating layers.

In some embodiments, a thickness of the second hard coating layer is less than a thickness of the first hard coating layer.

In another aspect, a foldable display apparatus is provided. The foldable display apparatus includes a foldable display module and a middle frame. The middle frame is disposed on a non-light-exit side of the foldable display module.

### BRIEF DESCRIPTION OF THE DRAWINGS

In order to describe technical solutions in the present disclosure more clearly, the accompanying drawings to be used in some embodiments of the present disclosure will be introduced briefly. However, the accompanying drawings to be described below are merely drawings of some embodiments of the present disclosure, and a person of ordinary skill in the art can obtain other drawings according to these accompanying drawings. In addition, the accompanying drawings to be described below may be regarded as schematic diagrams, and are not limitations on actual sizes of products involved in the embodiments of the present disclosure.

FIG. 1 is a structural diagram of a foldable display module in an unfolded state, in accordance with some embodiments;

FIG. 2 is a structural diagram of a foldable display module in a folded state, in accordance with some embodiments;

FIG. 3 is a structural diagram of a foldable display module in an intermediate state, in accordance with some embodiments;

FIG. 4 is a structural diagram of a foldable display apparatus, in accordance with some embodiments;

FIG. 5 is a structural diagram of another foldable display apparatus, in accordance with some embodiments;

FIG. 6 is a structural diagram of a foldable display module, in accordance with some embodiments;

FIG. 7 is a structural diagram of another foldable display module, in accordance with some embodiments;

FIG. 8 is a structural diagram of yet another foldable display module, in accordance with some embodiments;

FIG. 9 is a structural diagram of yet another foldable display module, in accordance with some embodiments;

FIG. 10 is a structural diagram of yet another foldable display module, in accordance with some embodiments;

FIG. 11 is a structural diagram of yet another foldable display module, in accordance with some embodiments;

FIG. 12A is a structural diagram of yet another foldable display apparatus, in accordance with some embodiments;

FIG. 12B is a structural diagram of yet another foldable display apparatus, in accordance with some embodiments;

FIG. 13 is a structural diagram of a support layer of a foldable display module, in accordance with some embodiments;

FIG. 14 is a structural diagram of a foldable display module in an implementation;

FIG. 15 is a structural diagram of another foldable display module in an implementation;

FIG. 16 is a structural diagram of a foldable display module in another implementation;

FIG. 17 is a structural diagram of another foldable display module in another implementation;

FIG. 18 is a simulation diagram of a foldable display module in another implementation;

FIG. 19 is a structural diagram of yet another foldable display module, in accordance with some embodiments;

FIG. 20A is a sectional view taken along the line C-C′ in FIG. 19;

FIG. 20B is another sectional view taken along the line C-C′ in FIG. 19;

FIG. 21 is a bottom view of a flexible display panel and an adhesive layer, in accordance with some embodiments;

FIG. 22 is a simulation diagram of a foldable display module, in accordance with some embodiments;

FIG. 23 is a structural diagram of a support layer of a foldable display module, in accordance with some other embodiments;

FIG. 24 is a sectional view taken along the line D-D′ in FIG. 19;

FIG. 25 is a bottom view of a flexible display panel and an adhesive layer, in accordance with some other embodiments;

FIG. 26 is a bottom view of a flexible display panel and an adhesive layer, in accordance with yet some other embodiments;

FIG. 27 is a bottom view of a flexible display panel and an adhesive layer, in accordance with yet some other embodiments;

FIG. 28 is a bottom view of a flexible display panel and an adhesive layer, in accordance with yet some other embodiments;

FIG. 29 is a bottom view of a flexible display panel and an adhesive layer, in accordance with yet some other embodiments;

FIG. 30 is a bottom view of a flexible display panel and an adhesive layer, in accordance with yet some other embodiments;

FIG. 31 is a bottom view of a flexible display panel and an adhesive layer, in accordance with yet some other embodiments;

FIG. 32 is a bottom view of a flexible display panel and an adhesive layer, in accordance with yet some other embodiments;

FIG. 33 is a bottom view of a flexible display panel and an adhesive layer, in accordance with yet some other embodiments;

FIG. 34 is a bottom view of a flexible display panel and an adhesive layer, in accordance with yet some other embodiments;

FIG. 35 is a structural diagram of yet another foldable display apparatus, in accordance with some embodiments;

FIG. 36 is a structural diagram of a support layer, a buffer layer and a fourth fixed sub-layer as a whole being attached to a back film and a flexible display panel, in accordance with some embodiments;

FIG. 37 is a structural diagram of yet another foldable display module, in accordance with some embodiments;

FIG. 38 is a structural diagram of yet another foldable display apparatus, in accordance with some embodiments; and

FIG. 39 is a structural diagram of yet another foldable display apparatus, in accordance with some embodiments.

### DESCRIPTION OF THE INVENTION

The technical solutions in some embodiments of the present disclosure will be described clearly and completely with reference to the accompanying drawings. However, the described embodiments are merely some but not all embodiments of the present disclosure. All other embodiments obtained on the basis of the embodiments of the present disclosure by a person of ordinary skill in the art shall be included in the protection scope of the present disclosure.

Unless the context requires otherwise, throughout the description and the claims, the term “comprise” and other forms thereof such as the third-person singular form “comprises” and the present participle form “comprising” are construed as an open and inclusive meaning, i.e, “including, but not limited to”. In the description of the specification, the term such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above term do not necessarily refer to the same embodiment(s) or example(s). In addition, specific features, structures, materials or characteristics may be included in any one or more embodiments or examples in any suitable manner.

Hereinafter, the terms such as “first” and “second” are used for descriptive purposes only, but are not to be construed as indicating or implying the relative importance or implicitly indicating the number of indicated technical features. Thus, features defined with “first” and “second” may explicitly or implicitly include one or more of the features. In the description of the embodiments of the present disclosure, the term “multiple,” “a plurality of” or “the plurality of” means two or more unless otherwise specified.

In the description of some embodiments, terms such as “connected” and derivatives thereof may be used. The term “connected” should be understood in a broad sense. For example, the term “connected” may represent a fixed connection, or a detachable connection, or a one-piece connection; alternatively, the term “connected” may represent a direct connection, or an indirect connection through an intermediate medium. The embodiments disclosed herein are not necessarily limited to the context herein.

In addition, the phase “based on” used is meant to be open and inclusive, since a process, step, calculation or other action that is “based on” one or more of the stated conditions or values may, in practice, be based on additional conditions or value exceeding those stated.

The term such as “about”, “substantially” or “approximately” as used herein includes a stated value and an average value within an acceptable range of deviation of a particular value determined by a person of ordinary skill in the art, considering measurement in question and errors associated with measurement of a particular quantity (i.e., limitations of a measurement system).

The term such as “perpendicular” or “equal” as used herein includes a stated case and a case similar to the stated case within an acceptable range of deviation determined by a person of ordinary skill in the art, considering measurement in question and errors associated with measurement of a particular quantity (i.e., limitations of a measurement system). For example, the term “perpendicular” includes absolute perpendicularity and approximate perpendicularity, and an acceptable range of deviation of the approximate perpendicularity may be a deviation within 5°; and the term “equal” includes absolute equality and approximate equality, and an acceptable range of deviation of the approximate equality may be a difference between two equals being less than or equal to 5% of either of the two equals.

It will be understood that, in a case where a layer or component is referred to as being on another layer or a substrate, it may be that the layer or component is directly on the another layer or substrate; or it may be that intermediate layer(s) exist between the layer or component and the another layer or substrate.

Exemplary embodiments are described herein with reference to sectional views and/or plan views as idealized exemplary drawings. In the accompanying drawings, thicknesses of layers and sizes of regions are enlarged for clarity. Thus, variations in shape with respect to the accompanying drawings due to, for example, manufacturing technologies and/or tolerances may be envisaged. Therefore, the exemplary embodiments should not be construed as being limited to the shapes of the regions shown herein, but including shape deviations due to, for example, manufacturing. For example, an etched region shown in a rectangular shape generally has a feature of being curved. Therefore, the regions shown in the accompanying drawings are schematic in nature, and their shapes are not intended to show actual shapes of the regions in an apparatus, and are not intended to limit the scope of the exemplary embodiments.

With the continuous development of display technology, foldable display apparatuses, as a new type of display apparatuses, are becoming more and more popular and are gradually being applied to all aspects of life.

Based on this, some embodiments of the present disclosure provide a foldable display apparatus. The foldable display apparatus may include, but is not limited to, any product or component having a display function, such as a notebook computer, a tablet computer, a mobile phone, a laptop computer, a personal digital assistant (PDA), a personal computer, a navigator, a vehicle-mounted device, a wearable device (e.g., a smart watch), an augmented reality (AR) device, or a virtual reality (VR) device. The embodiments of the present disclosure do not particularly limit a specific form of the foldable display apparatus.

For the convenience of the following description and illustration, the present disclosure will be described by taking an example in which the foldable display apparatus is a mobile phone. However, this cannot be regarded as a specific limitation on the structural form of the foldable display apparatus.

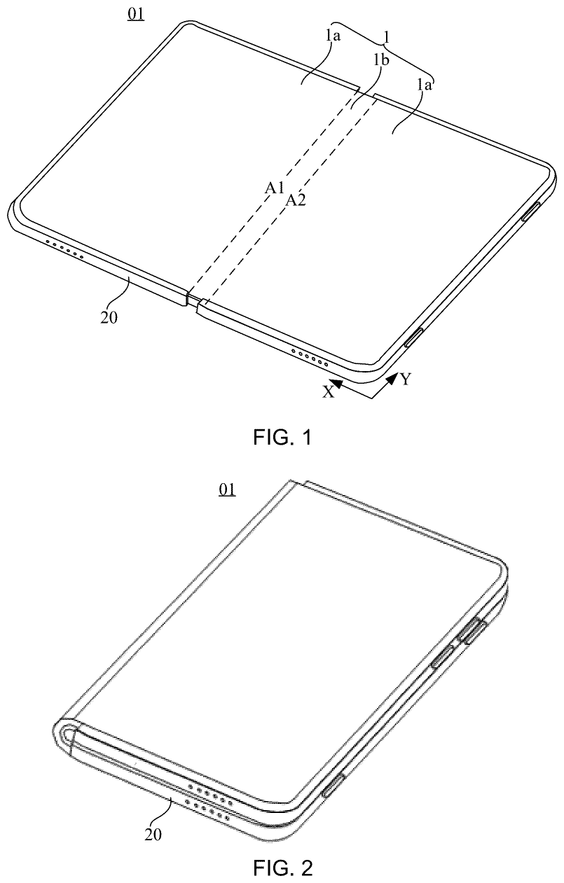

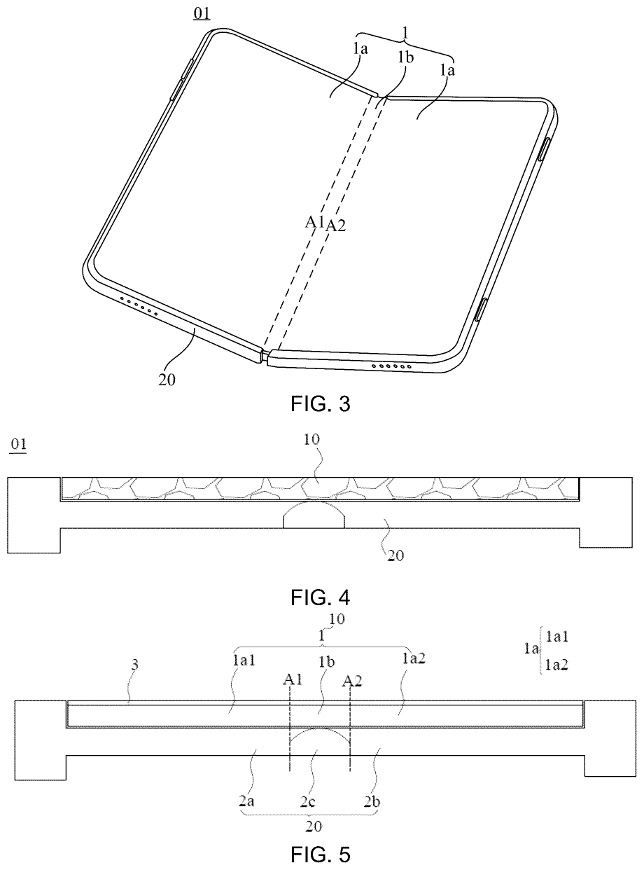

It will be understood that, under different usage requirements, as shown in FIG. 1, the foldable display apparatus 01 may be unfolded to be in an unfolded state; or, as shown in FIG. 2, the foldable display apparatus 01 may be folded to be in a folded state; or, as shown in FIG. 3, the foldable display apparatus 01 may be in an intermediate state between the unfolded state and the folded state. That is to say, the foldable display apparatus 01 has at least two states, i.e., the unfolded state and the folded state. In some cases, the foldable display apparatus 01 may further have a third state, i.e., the intermediate state between the unfolded state and the folded state. It will be understood that the intermediate state may be any one or more states between the unfolded state and the folded state of the foldable display apparatus 01, rather than a unique state.

For example, if the user needs to carry the foldable display apparatus 01 when going around, the foldable display apparatus 01 may be in the folded state, thereby reducing the volume of the foldable display apparatus 01 for easy carrying. For another example, if the user needs to use the foldable display apparatus 01 for viewing, the foldable display apparatus 01 may be in the unfolded state, thereby increasing the viewing area, improving the viewing effect, and improving the user experience.

In some embodiments, as shown in FIG. 4, the foldable display apparatus 01 includes a foldable display module 10 and a middle frame 20. The middle frame 20 is disposed on a non-light-exit side of the foldable display module 10. The foldable display module 10 is capable of displaying images. The middle frame 20 is capable of providing support and protection for the foldable display module 10.

It will be understood that the foldable display module 10 has a light-exit side and a non-light-exit side. The light-exit side refers to a side that the foldable display module 10 can emit light. The non-light-exit side refers to a side facing away from the light-exit side.

Optionally, the foldable display module 10 further includes a back cover located on a side of the middle frame 20 away from the foldable display module 10, and a circuit board, a camera, a battery and other electronic devices located between the middle frame 20 and the back cover.

In some embodiments, as shown in FIG. 5, the foldable display module 10 includes a flexible display panel 1.

It will be understood that, according to different folding directions of the flexible display panel 1, the foldable display apparatus 01 may be divided into an inward folding apparatus and an outward folding apparatus. The inward folding apparatus means that: when the foldable display apparatus 01 is in the folded state, the image displayed by the flexible display panel 1 cannot be viewed by the user; and when the foldable display apparatus 01 is in the unfolded state, the image displayed by the flexible display panel 1 can be viewed by the user. The outward folding apparatus means that: when the foldable display apparatus 01 is in the folded state, the image displayed by the flexible display panel 1 can be viewed by the user.

The drawings of the embodiments of the present disclosure are illustrated by taking an example in which the foldable display apparatus 01 is the inward folding apparatus.

In some examples, the flexible display panel 1 may be an organic light-emitting diode (OLED) display panel, a quantum dot light-emitting diode (QLED) display panel, etc. The OLED display panel is a self-luminous display panel and does not need to be provided with a backlight module (BLM), which is conducive to reducing a thickness and structural complexity of the foldable display apparatus 01.

For example, the OLED display panel may be an active matrix organic light-emitting diode (AMOLED) display panel.

In some examples, a thickness of the flexible display panel 1 is in a range from 20 μm to 50 μm. For example, the thickness of the flexible display panel 1 may be 20 μm, 25 μm, 30 μm, 40 μm, 42 μm, 43 μm, 47 μm or 50 μm.

In some examples, the flexible display panel 1 may include a substrate and a film layer stacked structure (including but not limited to pixel circuits, light-emitting devices, shift registers, etc.) disposed on the substrate. The substrate provides support for the film layer stacked structure, and the film layer stacked structure performs image display.

For example, the substrate may be made of a flexible resin material, including but not limited to polyethylene terephthalate (PET).

In some examples, as shown in FIGS. 1 and 5, the flexible display panel 1 includes a plurality of first display portions 1a and at least one second display portion 1b. For example, when the foldable display apparatus 01 is in the unfolded state, the plurality of first display portions 1a are sequentially arranged in a first direction X, and the second display portion 1b is located between two adjacent first display portions 1a. The second display portion 1b is bendable, and a bending axis is along a second direction Y. The first direction X is perpendicular to the second direction Y.

In this way, during the folding process of the foldable display apparatus 01, the first display portion 1a can rotate by taking the second display portion 1b connected thereto as an axis. When the foldable display apparatus 01 is in the unfolded state, the flexible display panel 1 is also in the unfolded state. When the foldable display apparatus 01 is in the folded state, the flexible display panel 1 is also in the folded state. When the foldable display apparatus 01 is in the intermediate state, the flexible display panel 1 is also in the intermediate state.

For example, the first display portion 1a may be in a shape of a plate or a plane. The second display portion 1b may be in a shape of a strip extending in the second direction Y. The plurality of first display portions 1a and the second display portion 1b are of a one-piece structure.

It will be understood that the number of the first display portions 1a and the number of the second display portion(s) 1b may be determined according to the number of folding times of the foldable display apparatus 01. For example, when the foldable display apparatus 01 is folded only once, there may be two first display portions 1a and one second display portion 1b. For another example, when the foldable display apparatus 01 can be folded twice, there may be three first display portions 1a and two second display portions 1b.

For the convenience of the following description and illustration, as shown in FIG. 5, the present disclosure will be described by taking an example in which the flexible display panel 1 includes two first display portions 1a and one second display portion 1b. As shown in FIG. 5, the two first display portions 1a are a first display sub-portion 1a1 and a second display sub-portion 1a2.

In the relevant drawings, the dotted line A1 is used as a boundary line between the first display sub-portion 1a1 on the left and the second display portion 1b, and the dotted line A2 is used as a boundary line between the second display sub-portion 1a2 on the right and the second display portion 1b.

In this case, when the foldable display apparatus 01 includes the middle frame 20, for example, as shown in FIG. 5, the middle frame 20 includes a first sub-frame 2a, a second sub-frame 2b and a rotating mechanism 2c. The first sub-frame 2a and the second sub-frame 2b are both connected to the rotating mechanism 2c, and the rotating mechanism 2c is located between the first sub-frame 2a and the second sub-frame 2b. The first sub-frame 2a and the second sub-frame 2b are both capable of rotating around the rotating mechanism 2c. The first sub-frame 2a is disposed on a non-light-exit side of the first display sub-portion 1a1, the second sub-frame 2b is disposed on a non-light-exit side of the second display sub-portion 1a2, and the second display portion 1b is opposite to the rotating mechanism 2c.

The material of the first sub-frame 2a and the second sub-frame 2b may include but is not limited to metal, glass, plastic or ceramic.

In addition, the rotating mechanism 2c may be a hinge, a rotating shaft, or other structures.

In this way, during the folding process of the foldable display apparatus 01, the first sub-frame 2a may rotate around the rotating mechanism 2c to drive the first display sub-portion 1a1 to rotate, and the second sub-frame 2b may rotate around the rotating mechanism 2c to drive the second display sub-portion 1a2 to rotate. Thus, the flexible display panel 1 can be folded.

When the user is using the foldable display apparatus 01, the foldable display apparatus 01 may fall. Since the flexible display panel 1 has the film layer stacked structure that needs to directly participate in the display process, the film layer stacked structure needs to be protected to ensure that the display function of the flexible display panel 1 is realized normally.

In light of this, in some embodiments, as shown in FIG. 5, the foldable display module 10 further includes a protective layer 3 disposed on the flexible display panel 1. That is, the protective layer 3 is located on the light-exit side of the flexible display panel 1. The protective layer 3 may improve the structural strength of the surface of the flexible display panel 1, reduce the probability of the flexible display panel 1 being broken in the event of a collision, improve the reliability of the foldable display module 10, and improve the reliability of the foldable display apparatus 01.

It will be understood that the flexible display panel 1 has a light-exit side and a backlight side. The light-exit side of the flexible display panel 1 refers to a side that the flexible display panel 1 can emit light. The backlight side of the flexible display panel 1 refers to a side facing away from the light-exit side.

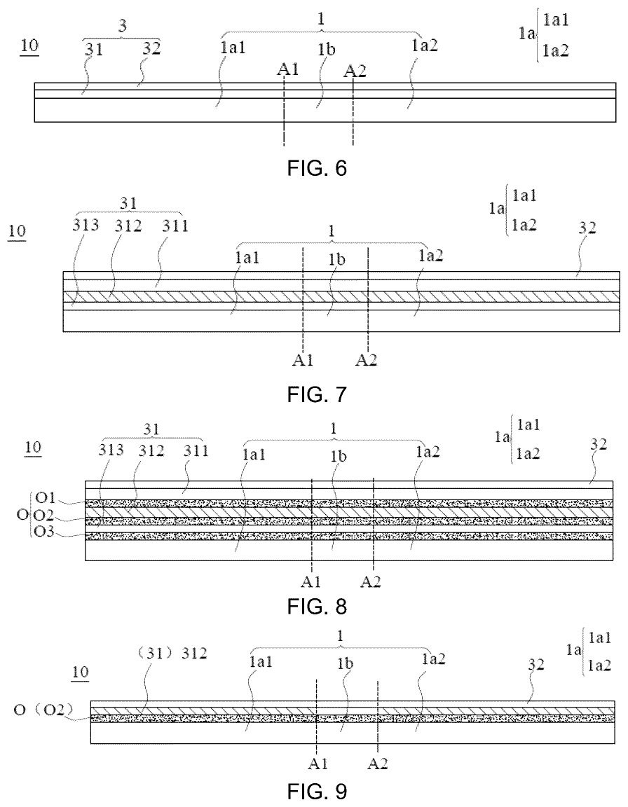

In some examples, as shown in FIG. 6, the protective layer 3 includes a first substrate layer 31 and a first hard coating (HC) layer 32. The first substrate layer 31 is disposed between the first HC layer 32 and the flexible display panel 1. The first substrate layer 31 provides support for the first HC layer 32 and provides protection for the flexible display panel 1. The first HC layer 32 improves the structural strength of the surface of the first substrate layer 31, thereby improving the structural strength of the surface of the flexible display panel 1.

For example, a thickness of the first HC layer 32 is in a range of 5 μm to 11 μm. For example, the thickness of the first HC layer 32 may be 5 μm, 6 μm, 7 μm, 8 μm or 11 μm. In this way, the protective layer 3 has an appropriate thickness, which may facilitate the bending of the foldable display module 10 and is beneficial for the light and thin design of the foldable display module 10. In addition, the protective layer 3 has good impact resistance, which may improve the structural strength of the surface of the flexible display panel 1, and in turn prevent surface damage of the flexible display panel 1 when subjected to external impact.

Optionally, considering an example in which the thickness of the first HC layer 32 is 8 μm, the first HC layer 32 of this thickness may well meet the bending requirements of the foldable display module 10, and well improve the structural strength of the surface of the flexible display panel 1.

For example, as shown in FIG. 7, the first substrate layer 31 may include a first sub-film 311, a transparent cover plate 312, and a second sub-film 313. The first sub-film 311 is located between the transparent cover plate 312 and the first HC layer 32, and the second sub-film 313 is located between the transparent cover plate 312 and the flexible display panel 1. The transparent cover plate 312 can provide protection for the flexible display panel 1. The first sub-film 311 and the second sub-film 313 can improve the bendable performance of the foldable display module 10.

The material of the transparent cover plate 312 may include ultra-thin glass (UTG). The UTG is capable of being rolled, bent or folded to facilitate the folding of the foldable display module 10. Moreover, the thickness of the UTG is much smaller than the thickness of ordinary glass. Therefore, the thickness of the foldable display module 10 may be reduced, which facilitates the light and thin design of the foldable display module 10.

For example, the thickness of the transparent cover plate 312 is in a range of 20 μm to 80 μm. For example, the thickness of the transparent cover plate 312 may be 20 μm, 30 μm, 40 μm, 50 μm or 80 μm.

In addition, the first sub-film 311 may be made of a flexible resin material, such as polyethylene terephthalate, colorless polyimide (CPI), or polyimide (PI). The second sub-film 313 may be made of a flexible resin material, such as polyethylene terephthalate, CPI, or PI.

Of course, the first substrate layer 31 may also only include the transparent cover plate 312. Alternatively, the first substrate layer 31 may include the transparent cover plate 312 and the first sub-film 311. Alternatively, the first substrate layer 31 may include the transparent cover plate 312 and the second sub-film 313.

Based on the different structural arrangements of the first substrate layer 31 described above, the foldable display module 10 in some embodiments of the present application further includes at least one fixed sub-layer O. The material of the fixed sub-layer O may include optically clear adhesive (OCA).

For example, as shown in FIG. 8, when the first substrate layer 31 includes the first sub-film 311, the transparent cover plate 312 and the second sub-film 313, there are three fixed sub-layers O, and the three fixed sub-layers O are respectively a first fixed sub-layer O1, a second fixed sub-layer O2 and a third fixed sub-layer O3. The first fixed sub-layer O1 is disposed between the first sub-film 311 and the transparent cover plate 312. The second fixed sub-layer O2 is disposed between the transparent cover plate 312 and the second sub-film 313. The third fixed sub-layer O3 is disposed between the second sub-film 313 and the flexible display panel 1. In this way, the first sub-film 311, the transparent cover plate 312, the second sub-film 313 and the flexible display panel 1 are fixed to each other, thereby improving the reliability of the foldable display module 10.

For example, as shown in FIG. 9, when the first substrate layer 31 includes the transparent cover plate 312, there is one fixed sub-layer O. The fixed sub-layer O includes a second fixed sub-layer O2 disposed between the transparent cover plate 312 and the flexible display panel 1. In this way, the transparent cover plate 312 and the flexible display panel 1 are fixed to each other, thereby improving the reliability of the foldable display module 10.

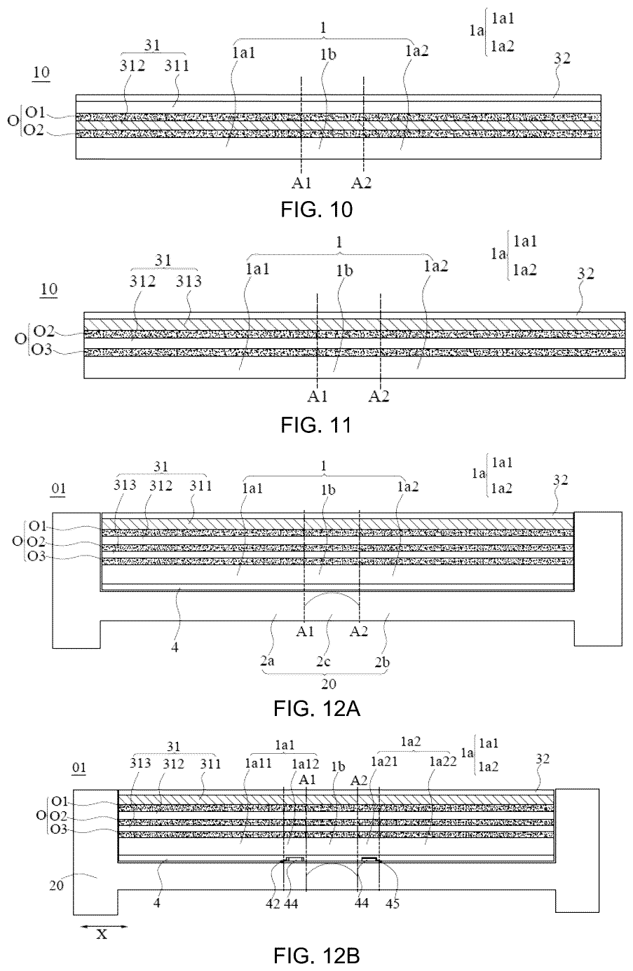

For example, as shown in FIG. 10, when the first substrate layer 31 includes the transparent cover plate 312 and the first sub-film 311, there are two fixed sub-layers O, and the two fixed sub-layers O are respectively a first fixed sub-layer O1 and a second fixed sub-layer O2. The first fixed sub-layer O1 is disposed between the first sub-film 311 and the transparent cover plate 312, and the second fixed sub-layer O2 is disposed between the transparent cover plate 312 and the flexible display panel 1. In this way, the first sub-film 311, the transparent cover plate 312 and the flexible display panel 1 are fixed to each other, thereby improving the reliability of the foldable display module 10.

For example, as shown in FIG. 11, when the first substrate layer 31 includes the transparent cover plate 312 and the second sub-film 313, there are two fixed sub-layers O, and the two fixed sub-layers O are respectively a second fixed sub-layer O2 and a third fixed sub-layer O3. The second fixed sub-layer O2 is disposed between the transparent cover plate 312 and the second sub-film 313, and the third fixed sub-layer O3 is disposed between the second sub-film 313 and the flexible display panel 1. In this way, the transparent cover plate 312, the second sub-film 313 and the flexible display panel 1 are fixed to each other, thereby improving the reliability of the foldable display module 10.

For the convenience of the following description, the following description will be illustrated by taking an example in which the first substrate layer 31 includes the first sub-film 311, the transparent cover plate 312 and the second sub-film 313, and there are three fixed sub-layers O including the first fixed sub-layer O1, the second fixed sub-layer O2 and the third fixed sub-layer O3.

During the use of the foldable display apparatus 01, in order to ensure that the foldable display apparatus 01 can be stably in a certain state (e.g., a folded state, an unfolded state or an intermediate state), the foldable display apparatus 01 needs to have a certain fixed ability.

Based on this, as shown in FIG. 12A, in some embodiments of the present disclosure, the foldable display module 10 further includes a support layer 4. The support layer 4 is disposed between the flexible display panel 1 and the middle frame 20. That is, the flexible display panel 1 is disposed on the support layer 4. In this way, when the foldable display apparatus 01 is unfolded or folded, the middle frame 20 will be unfolded or folded accordingly, and then the support layer 4 will be driven to be unfolded or folded, thereby driving the flexible display panel 1 to be unfolded or folded. The middle frame 20 and the support layer 4 cooperate with each other to enable the flexible display panel 1 to be stably in any suitable state of the folded state, the unfolded state or the intermediate state, thereby realizing a fixed effect of the flexible display panel 1.

In addition, since the support layer 4 has a certain rigidity, the support layer 4 can provide good support and protection for the flexible display panel 1, so as to improve impact resistance of a side of the flexible display panel 1 close to the support layer 4.

For example, a material of the support layer 4 includes metal. Optionally, the metal material may include stainless steel (SUS), titanium alloy, carbon fiber, etc. Of course, the material of the support layer 4 may also include other materials with certain toughness and rigidity.

In some examples, a thickness of the support layer 4 is in a range of 110 μm to 150 μm. For example, the thickness of the support layer 4 may be 110 μm, 115 μm, 117 μm, 120 μm, 130 μm, 140 μm, or 150 μm. In this way, the thickness of the support layer 4 is relatively appropriate, which facilitates the light and thin design of the foldable display module 10 and may facilitate the bending of the foldable display module 10. In addition, the support layer 4 has good impact resistance and can disperse the impact stress well to improve the structural strength of the side of the flexible display panel 1 close to the support layer 4 and reduce the probability of damage to the flexible display panel 1 during collision.

In some examples, in the present disclosure, the foldable display apparatus 01 in the folded state is in a shape of a “water droplet”. As shown in FIG. 12B, in the first direction X, the first display sub-portion 1a1 includes a first straight display sub-portion 1a11 and a first transition display sub-portion 1a12, and the first transition display sub-portion 1a12 is located between the first straight display sub-portion 1a11 and the second display portion 1b; the second display sub-portion 1a2 includes a second straight display sub-portion 1a22 and a second transition display sub-portion 1a21, and the second transition display sub-portion 1a21 is located between the second straight display sub-portion 1a22 and the second display portion 1b.

In this case, when the foldable display apparatus 01 is in the folded state, the first transition display sub-portion 1a12 is in a partly bent state, which is used to transition the second transition display sub-portion 1a21 to be in a partly bent state, so that the foldable display apparatus 01 as a whole is in a shape of a “water droplet”.

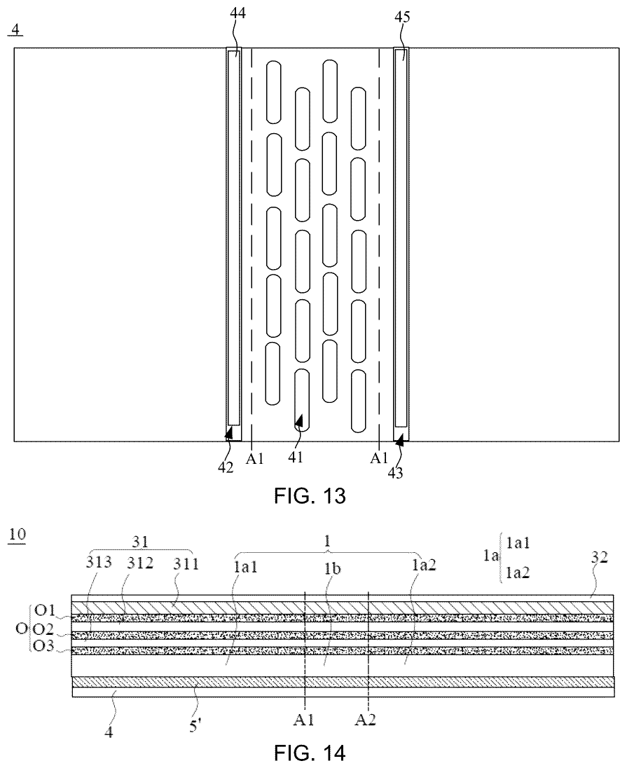

In this case, as shown in FIGS. 12B and 13, in some embodiments of the present disclosure, the foldable display module 10 further includes at least one first filling portion 44 and at least one second filling portion 45. The support layer 4 is provided therein with at least one first groove body 42 and at least one second groove body 43. An opening of the first groove body 42 and an opening of the second groove body 43 both face a side facing away from the flexible display panel 1. The first groove body 42 and the second groove body 43 both extend in a direction perpendicular to the first direction X. The first groove body 42 is located on the left side of the dotted line A1 and is disposed opposite to the first transition display sub-portion 1a12. The second groove body 43 is located on the right side of the dotted line A2 and is disposed opposite to the second transition display sub-portion 1a21. The first filling portion 44 is filled in the first groove body 42, and the second filling portion 45 is filled in the second groove body 43.

By providing the first groove body 42, it may be possible to reduce the thickness at a position where the first groove body 42 of the support layer 4 is located. When the foldable display apparatus 01 is in the folded state, it may be possible to weaken the bending stress at the position where the first groove body 42 of the support layer 4 is located, and avoid the problem of mutual pulling and separation between the first transition display sub-portion 1a12 and the support layer 4 due to bending.

Similarly, by providing the second groove 43, it may be possible to reduce the thickness at a position where the second groove body 43 of the support layer 4 is located. When the foldable display apparatus 01 is in the folded state, it may be possible to weaken the bending stress at the position where the second groove body 43 of the support layer 4 is located, and avoid the problem of mutual pulling and separation between the second transition display sub-portion 1a21 and the support layer 4 due to bending.

In addition, the first filling portion 44 and the second filling portion 45 may ensure that a surface of the support layer 4 away from the flexible display panel 1 maintains flat.

For example, in the direction perpendicular to the first direction X, the first groove body 42 may penetrate the support layer 4, and the second groove body 43 may penetrate the support layer 4.

For example, there may be one, two or three first groove bodies 42. In the case where there are a plurality of first groove bodies 42, the plurality of first groove bodies 42 may be sequentially arranged at intervals in the direction perpendicular to the first direction X. Alternatively, the plurality of first groove bodies 42 may be sequentially arranged at intervals in the first direction X.

Similarly, for example, there may be one, two or three second groove bodies 43. In the case where there are a plurality of second groove bodies 43, the plurality of second groove bodies 43 may be sequentially arranged at intervals in the direction perpendicular to the first direction X. Alternatively, the plurality of second groove bodies 43 may be sequentially arranged at intervals in the first direction X.

For example, a depth of the first groove body 42 may be approximately half of the thickness of the support layer 4. A depth of the second groove body 43 may be approximately half of the thickness of the support layer 4.

For example, when the thickness of the support layer 4 is in a range of 110 μm to 150 μm, the depth of the first groove body 42 is in a range of 55 μm to 75 μm. For example, the depth of the first groove body 42 may be 55 μm, 60 μm, 65 μm, 68 μm or 75 μm. The depth of the second groove body 43 is in a range of 55 μm to 75 μm. For example, the depth of the second groove body 43 may be 55 μm, 60 μm, or 65 μm. The depth of the first groove body 42 is in a range of 55 μm to 75 μm. For example, the depth of the first groove body 42 may be 55 μm, 60 μm, 65 μm, 68 μm or 75 μm, 64 μm, 67 μm, or 75 μm.

For example, a material of the first filling portion 44 may include, but is not limited to, polyethylene terephthalate. For example, a material of the second filling portion 45 may include, but is not limited to, polyethylene terephthalate.

In some examples, as shown in FIG. 13, the support layer 4 is provided therein with a plurality of through holes 41. When the foldable display apparatus 01 is in the unfolded state, a plane where the support layer 4 is located is a first plane (a plane where the paper of FIG. 13 is located), and orthogonal projections of the plurality of through holes 41 on the first plane are located within an orthogonal projection of the second display portion 1b on the first plane. The through holes 41 may reduce the bending resistance of the support layer 4 and reduce the maximum bending stress of the support layer 4 during the bending process, so that the fatigue resistance of the support layer 4 meets the actual use requirements.

It will be understood that the number and size of the through holes 41 may be reasonably set according to the material, thickness and size of the support layer 4.

The plurality of through holes 41 may be any one or a combination of elliptical holes, square holes, circular holes or irregular-shaped holes.

For example, the plurality of sub-pixels P may be arranged in an array. Alternatively, the plurality of through holes 41 may be arranged randomly.

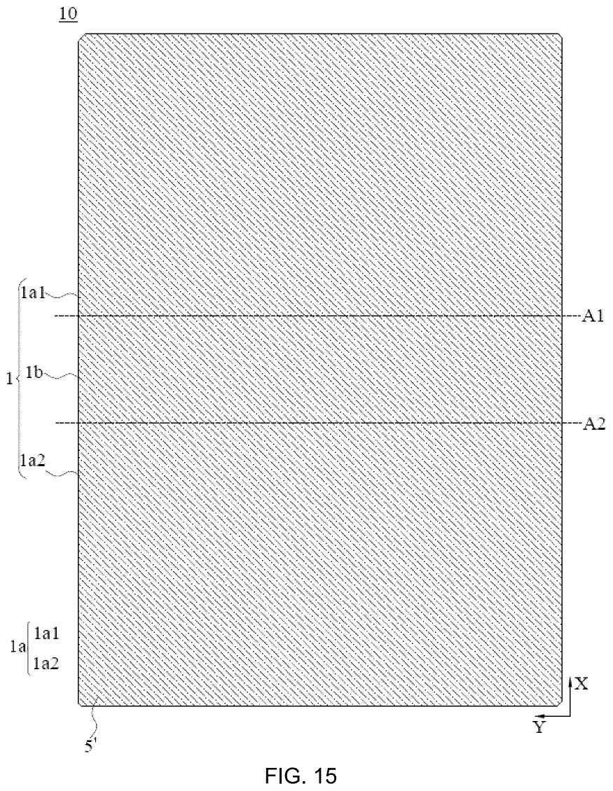

The support layer 4 and the flexible display panel 1 need to have a stable connection. Therefore, in a possible implementation, as shown in FIGS. 14 and 15, an adhesive layer 5′ is provided between the support layer 4 and the flexible display panel 1. An orthogonal projection of the adhesive layer 5′ on the first plane (a plane where the paper of FIG. 15 is located) coincides with an orthogonal projection of the flexible display panel 1 on the first plane, so that the adhesive layer 5′ is used to bond the support layer 4 and the flexible display panel 1 together.

However, during each folding process of the foldable display apparatus 01, the second display portion 1b will bend and deform. During the deformation process, the support layer 4 and the second display portion 1b will frequently squeeze a portion of the adhesive layer 5′ located therebetween, resulting in irreversible deformation of the adhesive layer 5′. Since the second display portion 1b is bonded to the adhesive layer 5′, the deformation of the adhesive layer 5′ will be transferred to the second display portion 1b. Thus, the second display portion 1b will be deformed along with the deformation of the adhesive layer 5′, leading to crease on the second display portion 1b.

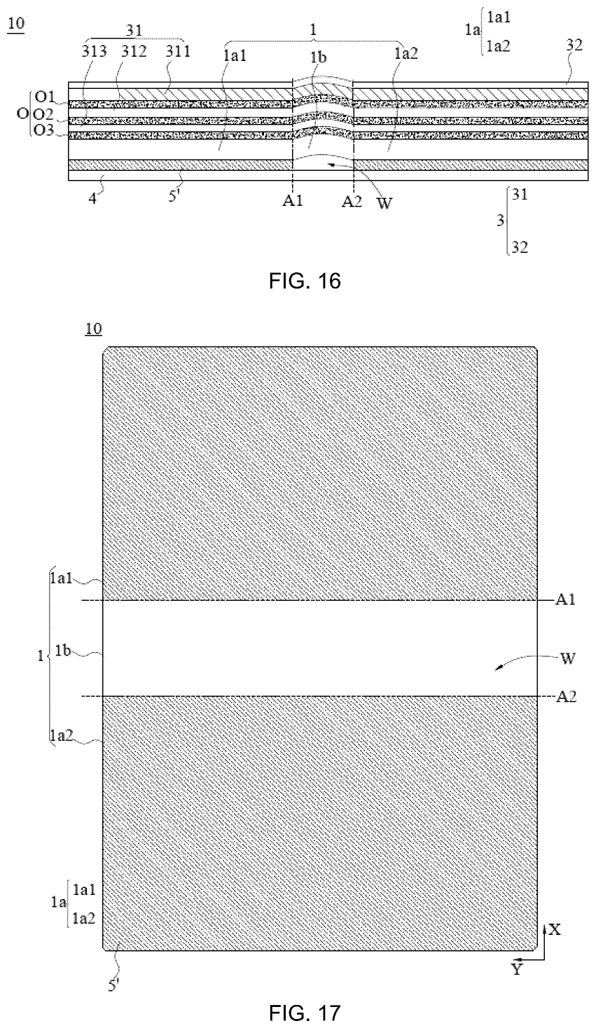

Based on this, as shown in FIGS. 16 and 17, in another possible implementation, the portion of the adhesive layer 5′ located between the second display portion 1b and the support layer 4 (the region W in FIGS. 16 and 17) is removed. That is, the adhesive is discontinuous to weaken the crease on the second display portion 1b.

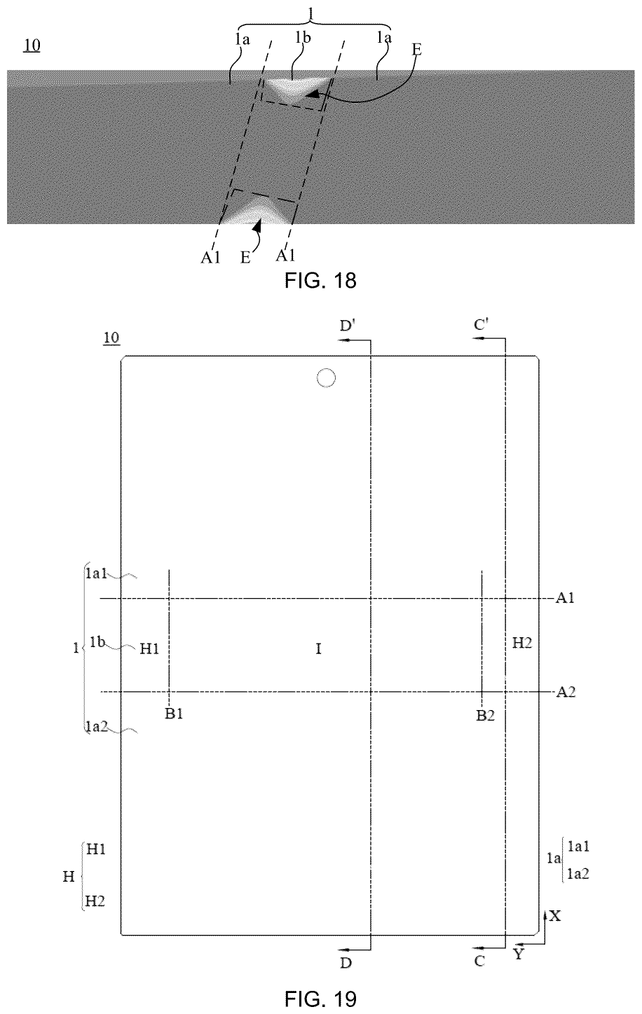

However, since the first HC layer 32 of the protective layer 3 has cohesive force, an edge of the protective layer 3 will be warped upward toward a side away from the flexible display panel 1 due to the cohesive force. Since the portion of the adhesive layer 5′ located between the second display portion 1b and the support layer 4 is removed, the second display portion 1b and the support layer 4 are spaced apart and not in direct contact, as shown in FIG. 16. In this case, after the protective layer 3 is bonded to the flexible display panel 1, due to the upward pulling force of the edge of the protective layer 3, as shown in FIGS. 16 and 18, an edge of the second display portion 1b (the region E in FIG. 18) may also be warped upward, causing an defect phenomenon of unsmooth light and shadow of the flexible display panel 1.

In light of this, as shown in FIG. 19, in some embodiments of the present disclosure, the second display portion 1b has a non-adhesive region I and two adhesive regions H. For example, the two adhesive regions H are a first adhesive region H1 and a second adhesive region H2. The two adhesive regions H are respectively located on two opposite sides of the non-adhesive region I in the second direction Y. As shown in FIG. 19, the dotted line B1 is used as a dividing line between the first adhesive region H1 on the left and the non-adhesive region I, and the dotted line B2 is used as a dividing line between the second adhesive region H2 on the right and the non-adhesive region I.

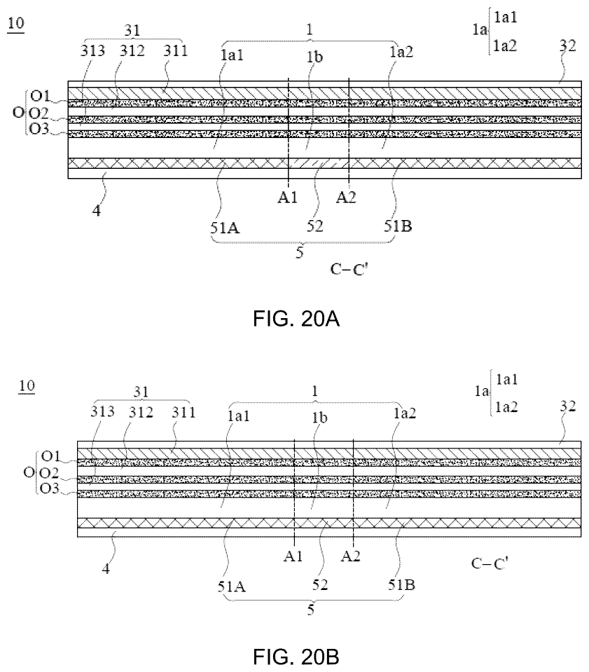

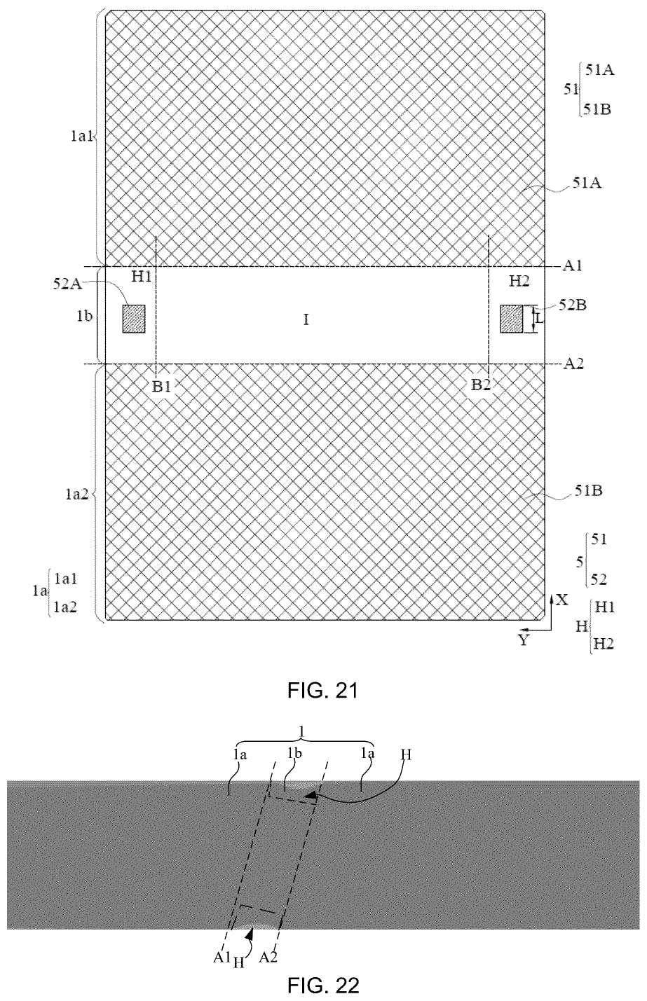

As shown in FIGS. 20A and 21, in some embodiments of the present disclosure, an adhesive layer 5 included in the foldable display module 10 is located on the support layer 4, and the flexible display panel 1 is located on the adhesive layer 5. The adhesive layer 5 includes a plurality of first adhesive portions 51 and a plurality of second adhesive portions 52. A first adhesive portion 51 is arranged between a first display portion 1a and the support layer 4, and at least one second adhesive portion 52 is arranged in an adhesive region H.

It will be noted that the flexible display panel 1 is located on the adhesive layer 5, which means that the flexible display panel 1 may be in direct contact with the adhesive layer 5, or there may be another film layer provided between the flexible display panel 1 and the adhesive layer 5, that is, the flexible display panel 1 is in indirect contact with the adhesive layer 5.

It will be understood that the first adhesive portion 51 fills up a region between the first display portion 1a and the support layer 4.

It will be noted that, as shown in FIG. 21, a left border of the first adhesive region H1 coincides with a left border of the second display portion 1b, and a right border of the second adhesive region H2 coincides with a right border of the second display portion 1b. That is, the above-mentioned left edge of the second display portion 1b corresponds to a part of the second display portion 1b located in the first adhesive region H1, and the above-mentioned right edge of the second display portion 1b corresponds to a part of the second display portion 1b located in the second adhesive region H2. Therefore, an edge of the second display portion 1b mentioned below should have the same meaning as a part of the second display portion 1b located in an adhesive region H.

An area of the first adhesive region H1 and an area of the second adhesive region H2 may be the same or difference. For example, the area of the first adhesive region H1 is greater than the area of the second adhesive region H2. For another example, the area of the first adhesive region H1 is less than the area of the second adhesive region H2.

In some examples, second adhesive portions 52 in the two adhesive regions H may be equal in quantity. For example, as shown in FIG. 21, there is one second adhesive portion 52 in each of the two adhesive regions H. Alternatively, there are three second adhesive portions 52 in each of the two adhesive regions H.

In some other examples, second adhesive portions 52 in the two adhesive regions H may be different in quantity. For example, there is one second adhesive portion 52 in an adhesive region H, and there are two second adhesive portions 52 in another adhesive region H. For another example, there are two second adhesive portions 52 in an adhesive region H, and there are three second adhesive portions 52 in another adhesive region H.

In the case where there are a plurality of second adhesive portions 52 arranged in an adhesive region H, the plurality of second adhesive portions 52 may be arranged in an array or may be arranged randomly.

In some examples, as shown in FIG. 20B, a material of the adhesive layer 5 may include pressure-sensitive adhesive. That is, a first adhesive sub-portion 51A, a second adhesive sub-portion 51B, a third adhesive sub-portion 52A, and a fourth adhesive sub-portion 52B are made of the same material. In this way, it may be possible to ensure that the adhesive layer 5 has strong elasticity and is less prone to breakage, and a stable connection between the support layer 4 and the flexible display panel 1 can still be guaranteed after the foldable display module 10 is bent multiple times. Of course, the adhesive layer 5 may also be made of any other suitable material.

A thickness of the adhesive layer 5 is in a range of 15 μm to 55 μm. For example, the thickness of the adhesive layer 5 may be 15 μm, 20 μm, 25 μm, 40 μm, or 55 μm.

Optionally, the thickness of the adhesive layer 5 may be in a range of 15 μm to 25 μm. For example, the thickness of the adhesive layer 5 may be 15 μm, 17 μm, 20 μm, 23 μm, or 25 μm. In this way, the thickness of the adhesive layer 5 is relatively appropriate, which may realize the stable connection between the support layer 4 and the flexible display panel 1 and also facilitate the light and thin design of the foldable display module 10.

For example, the thickness of the adhesive layer 5 is 20 μm, which may realize a more stable connection between the support layer 4 and the flexible display panel 1, and also be more conducive to the light and thin design of the foldable display module 10.

Of course, as shown in FIG. 20A, the materials of the first adhesive sub-portion 51A, the second adhesive sub-portion 51B, the third adhesive sub-portion 52A, and the fourth adhesive sub-portion 52B may be completely or partially different.

For the convenience of the following description, the first adhesive portion 51 located between the first display sub-portion 1a1 and the support layer 4 is named the first adhesive sub-portion 51A, and the first adhesive portion 51 located between the second display sub-portion 1a2 and the support layer 4 is named the second adhesive sub-portion 51B. The second adhesive portion 52 located in the first adhesive region H1 is named the third adhesive sub-portion 52A, and the second adhesive portion 52 located in the second adhesive region H2 is named the fourth adhesive sub-portion 52B.

In this way, since no adhesive layer 5 is arranged in the non-adhesive region I, a part of the second display portion 1b located in the non-adhesive region I and the support layer 4 are spaced apart and are not directly connected. In this way, the problem of squeezing the adhesive layer 5 between the support layer 4 and the part of the second display portion 1b located in the non-adhesive region I will not occur. Therefore, during the repeated folding process of the foldable display module 10, the crease on the second display portion B will be alleviated.

Since the second adhesive portion 52 is arranged in the adhesive region H, the second adhesive portion 52 can bond the part of the second display portion 1b located in the adhesive region H to the support layer 4. In this way, even though the protective layer 3 acts on the part of the second display portion 1b located in the adhesive region H with an upward pulling force, causing the part of the second display portion 1b located in the adhesive region H has a tendency to warp upward, the support layer 4 is connected to the part of the second display portion 1b located in the adhesive region H through the second adhesive portion 52, which may provide the part of the second display portion 1b located in the adhesive region H with a downward pulling force close to the support layer 4, balancing the upward pulling force of the protective layer 3 on the part of the second display portion 1b located in the adhesive region H. Therefore, the part of the second display portion 1b located in the adhesive region H is pulled down to a nearly flat and straight state, which causes the entire flexible display panel 1 to be nearly flat and straight, as shown in FIG. 22. Thus, the phenomenon of unsmooth light and shadow at the edge of the flexible display panel 1 is mitigated, and the display effect of the foldable display module 10 is improved.

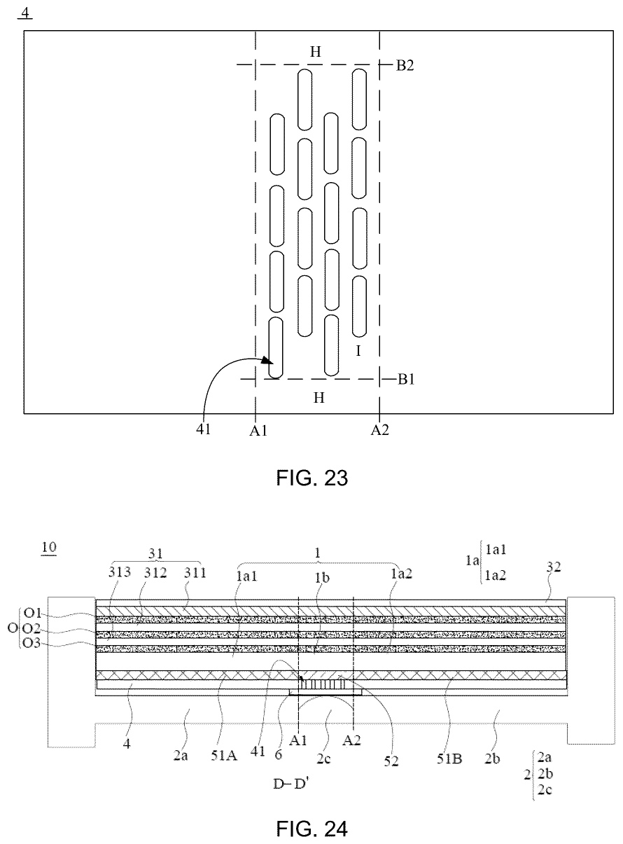

In some embodiments, as shown in FIG. 23, orthogonal projections of the plurality of through holes 41 on the second display portion 1b are located within the non-adhesive region I. In this way, there is no through hole 41 at a position where the second adhesive portion 52 and the support layer 4 are bonded, so that a stable connection between the second adhesive portion 52 and the support layer 4 may be realized, which improves the stability of the connection between the support layer 4 and the part of the second display portion 1b located in the adhesive region H, and well mitigates the problem of unsmooth light and shadow of the flexible display panel 1.

In this case, in some examples, as shown in FIG. 24, the foldable display module 10 further includes a dustproof layer 6 disposed between the middle frame 20 and the support layer 4, and the dustproof layer 6 covers the plurality of through holes 41 in the support layer 4. In this way, it is possible to prevent external dust and other debris from entering the space between the support layer 4 and the flexible display panel 1 through the through holes 41, and in turn prevent dust and other debris from contaminating the adhesive layer 5. Thus, the service life of the adhesive layer 5 is extended.

It will be understood that an orthogonal projection of the dustproof layer 6 on the first plane may coincide with the orthogonal projection of the second display portion 1b on the first plane. Alternatively, a part of the orthogonal projection of the dustproof layer 6 on the first plane may coincide with the orthogonal projection of the second display portion 1b on the first plane, and another part of the orthogonal projection of the dustproof layer 6 on the first plane coincides with an orthogonal projection of the first display portion 1a on the first plane.

When the support layer 4 and the flexible display panel 1 are bonded using the second adhesive portion 52, the stability of the bonding between the flexible display panel 1 and the support layer 4 needs to be guaranteed.

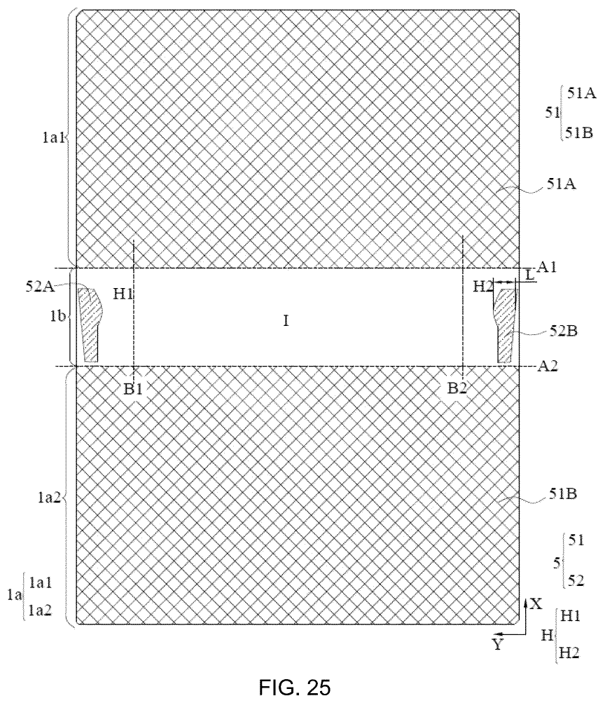

Based on this, as shown in FIG. 25, in some embodiments, a maximum size L of the second adhesive portion 52 in the second direction Y is in a range of 5 mm to 10 mm. The size of the second adhesive portion 52 in the second direction Y within this range is relatively appropriate. In this way, the second adhesive portion 52 may stably bond the part of the second display portion 1b located in the adhesive region H to the support layer 4, thereby preventing the part of the second display portion 1b located in the adhesive region H from warping upward toward the side away from the support layer 4. In addition, after the foldable display module 10 is repeatedly folded, the second adhesive portion 52 within this size range may also reduce the crease on the second display portion 1b, thereby improving the appearance of the flexible display panel 1.

For example, the range of the maximum size L of the second adhesive portion 52 may refer to a range of a maximum size L of the third adhesive sub-portion 52A and/or a range of a maximum size L of the fourth adhesive sub-portion 52B.

It will be noted that, the maximum size of the second adhesive portion 52 in the second direction Y includes the following two situations.

In the first situation, as shown in FIG. 21, in the second direction Y, when the size of the second adhesive portion 52 is equal everywhere, the maximum size of the second adhesive portion 52 refers to the size of the second adhesive portion 52.

In the second situation, as shown in FIG. 25, in the second direction Y, when the size of the second adhesive portion 52 is not uniform, the maximum size of the second adhesive portion 52 refers to the size of the largest part of the second adhesive portion 52.

For example, in the second direction Y, the maximum size of the second adhesive portion 52 may be 5 mm, 6 mm, 7 mm, 8 mm, 9 mm, or 10 mm. In this way, the size of the second adhesive portion 52 in the second direction Y is relatively appropriate. Therefore, the support layer 4 and the second display portion 1b may be bonded together more stably, which may well reduce the degree of the upward warping of the edge of the second display portion 1b and well mitigate the phenomenon of unsmooth light and shadow of the flexible display panel 1. In addition, the crease on the second display portion 1b may be well reduced, which improves the overall appearance of the foldable display module 10.

For example, the maximum size of the second adhesive portion 52 is 8 mm. In this way, it may be possible to ensure the stable connection between the part of the second display portion 1b located in the adhesive region H and the support layer 4 to a great extent. Moreover, the crease on the second display portion 1b may be well reduced, which improves the overall appearance of the foldable display module 10.

It will be understood that due to certain uncontrollable errors (such as manufacturing process errors, equipment accuracy, measurement errors, etc.), when an error floating range of the maximum size of the second adhesive portion 52 in the second direction Y fluctuates within a range of 5%×8 mm, it can also be considered that the maximum size of the second adhesive portion 52 satisfies and is equal to 8 mm.

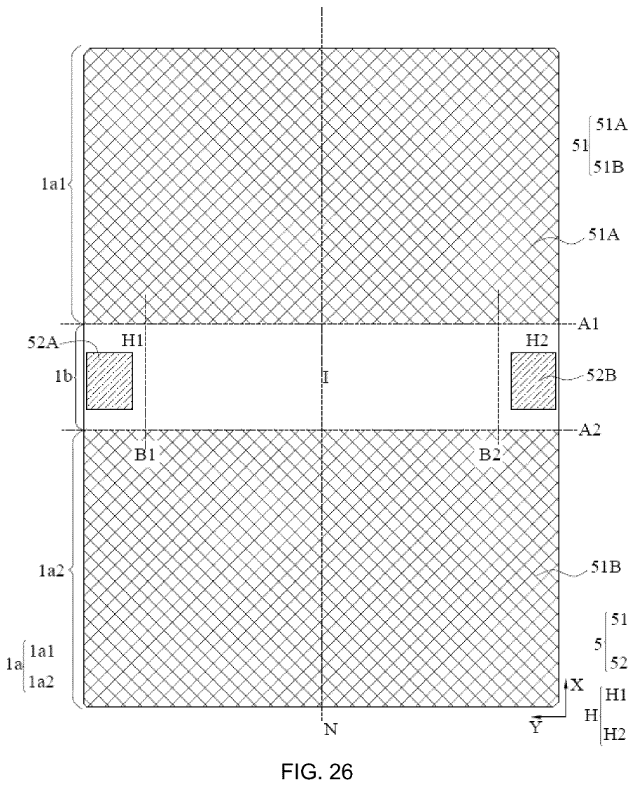

In some embodiments, as shown in FIG. 26, the non-adhesive region I has a center line N along the first direction X. The second adhesive portions 52 in the two adhesive regions H are symmetrically arranged about the center line N. In this way, the bonding force of the second adhesive portions 52 on two sides of the center line N acting on the second display portion 1b and the support layer 4 is in a balanced state. Thus, the support layer 4 and the part of the second display portion 1b located in the adhesive region H may be stably connected together to mitigate the degree of upward warping of the edge of the flexible display panel 1; in addition, in the process of bending the foldable display module 10, misalignment between the support layer 4 and the second display portion 1b may be avoided, so as to keep the foldable display module 10 in a normal state and to avoid abnormal folding.

It will be understood that the areas of the second adhesive portions 52 in the two adhesive regions H may be equal. For example, the area of the third adhesive sub-portion 52A is equal to the area of the fourth adhesive sub-portion 52B.

The symmetrical arrangement means that the second adhesive portion 52 in the first adhesive region H1 may coincide with the second adhesive portion 52 in the second adhesive region H2 after being flipped 180° about the center line N. For example, the third adhesive sub-portion 52A, after being flipped 180° about the center line N, may coincide with the fourth adhesive sub-portion 52B.

In some examples, the number of third adhesive sub-portions 52A and the number of fourth adhesive sub-portions 52B may be equal. For example, there is one third adhesive sub-portion 52A, and there is also one fourth adhesive sub-portion 52B. Alternatively, there are three third adhesive sub-portions 52A, and there are also three fourth adhesive sub-portions 52B.

In some examples, the third adhesive sub-portion 52A may fill up the first adhesive region H1, which may increase the connection stability between the support layer 4 and the part of the second display portion 1b located in the first adhesive region H1 to a great extent. Alternatively, the third adhesive sub-portion 52A may occupy a part of the first adhesive region H1.

In some examples, the fourth adhesive sub-portion 52B may fill up the second adhesive region H2, which may increase the connection stability between the support layer 4 and the part of the second display portion 1b located in the second adhesive region H2 to a great extent. Alternatively, the fourth adhesive sub-portion 52B may occupy a part of the second adhesive region H2.

In the process of actual arrangement of the second adhesive portion 52, the form of the second adhesive portion 52 may vary as long as the second display portion 1b and the support layer 4 can be bonded to each other. For example, the second adhesive portion 52 may be in a shape of a strip; or, the second adhesive portion 52 may include a connection portion 521 and a plurality of protruding portions 522. In order to more clearly understand the form of the second adhesive portion 52, the form of the second adhesive portion 52 will be described in detail below.

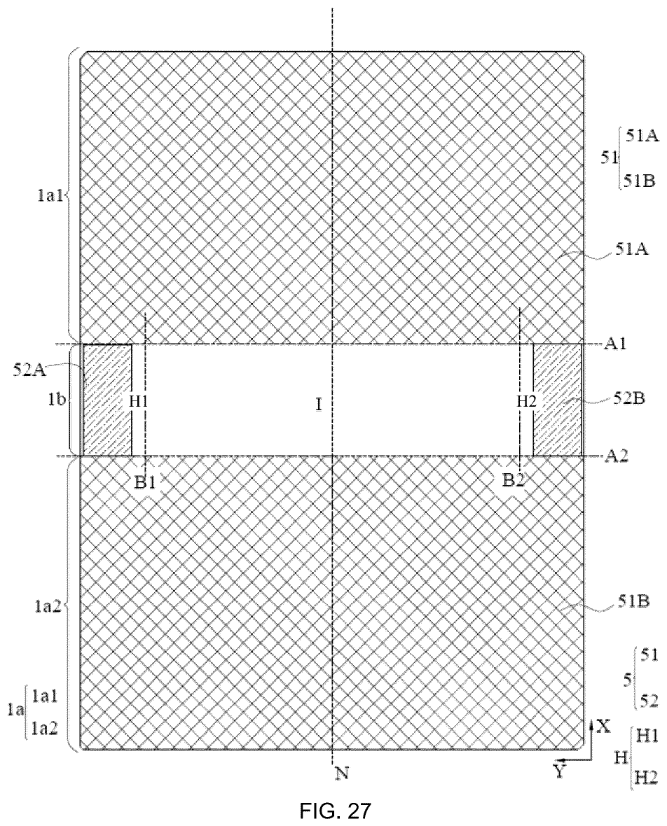

In a possible embodiment, as shown in FIG. 27, the second adhesive portion 52 is in a shape of a strip. In the first direction X, the second adhesive portion 52 is connected to two first adhesive portions 51 located on two opposite sides of the second adhesive portion 52. In this way, in the first direction X, the second adhesive portion 52 may span the entire adhesive region H, and more firmly bond the support layer 4 and the second display portion 1b together, thereby well reducing the degree of the upward warping of the part of the second display portion 1b located in the adhesive region H, and well mitigating the unsmooth light and shadow phenomenon of the flexible display panel 1.

For example, in the first direction X, the third adhesive sub-portion 52A may be connected to the first adhesive sub-portion 51A and the second adhesive sub-portion 51B; and/or, the fourth adhesive sub-portion 52B may be connected to the first adhesive sub-portion 51A and the second adhesive sub-portion 51B.

The first adhesive portions 51 and the second adhesive portion 52 may constitute a one-piece structure. In this way, the connection strength between the first adhesive portions 51 and the second adhesive portion 52 may be increased to improve the overall structural strength of the first adhesive portions 51 and the second adhesive portion 52, thereby more stably connecting the flexible display panel 1 and the support layer 4 together.

In addition, the second adhesive portion 52 may be of a square-shaped structure, for example, may be in a shape of a rectangle or square. Since the second adhesive portion 52 has a regular shape, the second adhesive portion 52 may be easily arranged. Alternatively, the second adhesive portion 52 may be of a parallelogram structure or an irregular curved structure.

For example, as shown in FIG. 27, there are one third adhesive sub-portion 52A and one fourth adhesive sub-portion 52B. An upper border of two borders of the third adhesive sub-portion 52A arranged in the first direction X coincides with the dotted line A1, and the lower border of the two borders of the third adhesive sub-portion 52A arranged in the first direction X coincides with the dotted line A2. A border, away from the non-adhesive region I, of two borders of the third adhesive sub-portion 52A arranged in the second direction Y coincides with a border of the second display portion 1b.

An upper border of two borders of the fourth adhesive sub-portion 52B arranged in the first direction X coincides with the dotted line A1, and the lower border of the two borders of the fourth adhesive sub-portion 52B arranged in the first direction X coincides with the dotted line A2. A border, away from the non-adhesive region I, of two borders of the fourth adhesive sub-portion 52B arranged in the second direction Y coincides with a border of the second display portion 1b.

In this way, the adhesive layer 5 is of a frame-shaped structure. That is, there is an opening enclosed by the first adhesive portion 51 and the second adhesive portion 52 in the middle of the adhesive layer 5, and the non-adhesive region I of the second display portion 1b is located within the opening. The opening may be in a shape of a square, circle, rhombus, ellipse, etc.

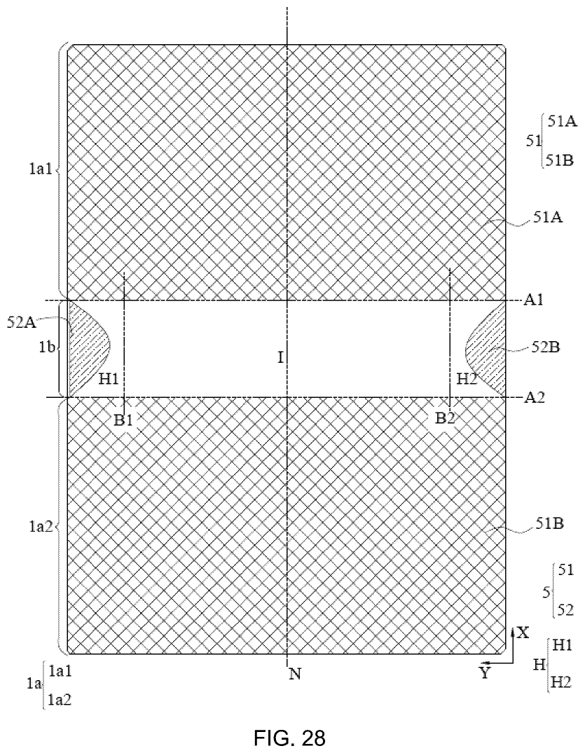

Based on the above-mentioned strip-shaped design of the second adhesive portion 52, in some embodiments, as shown in FIG. 28, a border of the second adhesive portion 52 close to the non-adhesive region I is curved, and this border protrudes toward a direction close to the non-adhesive region I. In this way, the border of the second adhesive portion 52 close to the non-adhesive region I is parabolic. The second adhesive portion 52 of this shape matches the state that the edge of the second display portion 1b warps upward in the simulation experiment as shown in FIG. 18. In this way, the edge of the second display portion 1b and the support layer 4 may be fixed purposefully, so as to well ameliorate the upward warping phenomenon of the edge of the second display portion 1b and mitigate the unsmooth light and shadow phenomenon of the flexible display panel 1.

For example, a border of the third adhesive sub-portion 52A close to the non-adhesive region I is curved and protrudes toward a direction close to the non-adhesive region I. And/or, a border of the fourth adhesive sub-portion 52B close to the non-adhesive region I is curved and protrudes toward a direction close to the non-adhesive region I.

In the actual manufacturing process of the foldable display module 10, the adhesive layer 5 is generally attached at once between the support layer 4 and the flexible display panel 1. However, since the first adhesive portion 51 and the second adhesive portion 52 are located in different positions and have different shapes, a suitable adhesive layer 5 needs to be processed using a cutting processing technology before adhesive bonding.

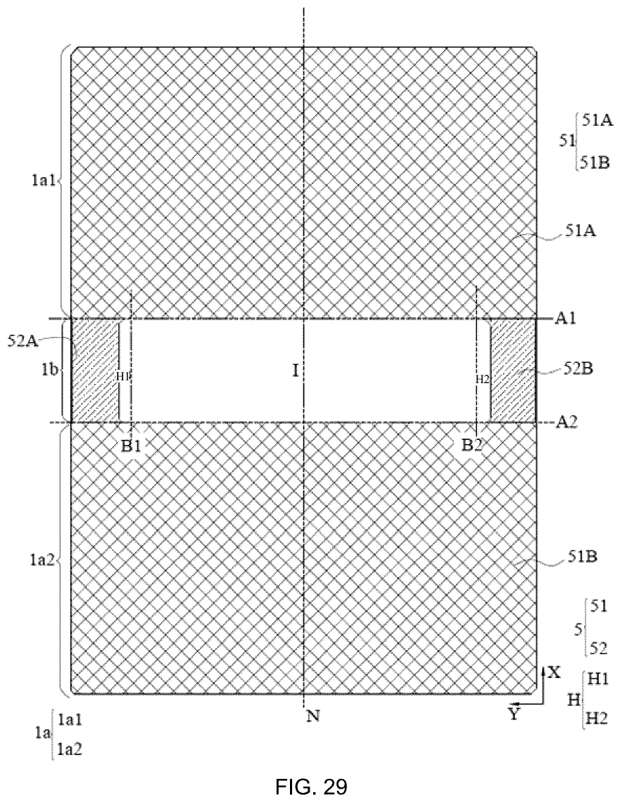

Based on this, in some embodiments, as shown in FIG. 29, a connection position between the second adhesive portion 52 and the first adhesive portion 51 is chamfered. In this way, when the first adhesive portion 51 and the second adhesive portion 52 are formed by cutting with a cutting tool, it facilitates the cutting and material discharge (removing a redundant portion of the adhesive layer 5) at the connection position between the first adhesive portion 51 and the second adhesive portion 52. Moreover, the chamfer structure may also reduce the requirements on the cutting tool and reduce the fabrication cost.

For example, a connection position between the first adhesive sub-portion 51A and the third adhesive sub-portion 52A is chamfered; and/or, a connection position between the first adhesive sub-portion 51A and the fourth adhesive sub-portion 52B is chamfered; and/or, a connection position between the second adhesive sub-portion 51B and the third adhesive sub-portion 52A is chamfered; and/or, a connection position between the second adhesive sub-portion 51B and the fourth adhesive sub-portion 52B is chamfered.

The connection position between the second adhesive portion 52 and the first adhesive portion 51 is chamfered, which may have a rounded chamfer or an oblique chamfer.

When the connection position between the second adhesive portion 52 and the first adhesive portion 51 has the rounded chamfer, a radius of a rounded corner may be set according to actual needs. When the connection position between the second adhesive portion 52 and the first adhesive portion 51 forms the oblique chamfer, an inclination of an oblique edge of the oblique chamfer may be 45° or 60°.

In some examples, as shown in FIG. 29, in the second direction Y, when a border of the second adhesive portion 52 away from the non-adhesive region I coincides with a border of the flexible display panel 1, only the connection position between the border of the second adhesive portion 52 close to the non-adhesive region I and the first adhesive portion 51 is chamfered.

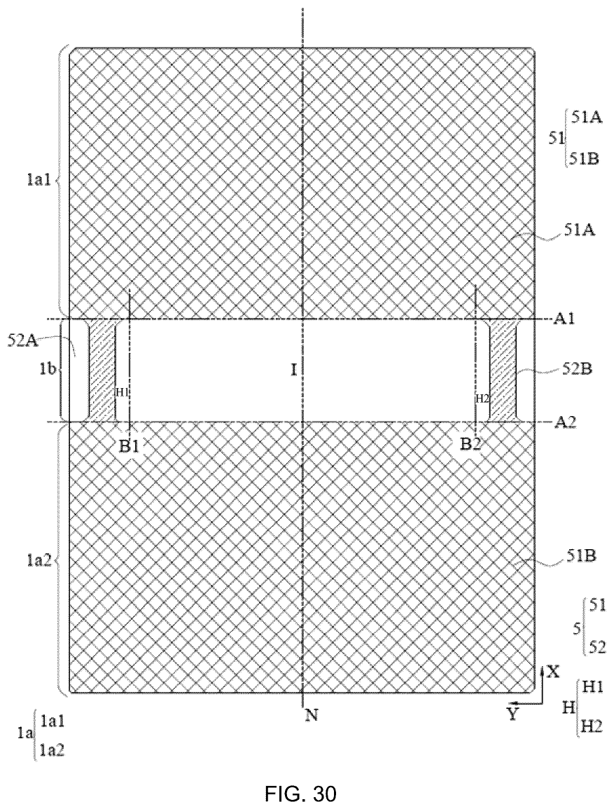

In some other examples, as shown in FIG. 30, in the second direction Y, when the border of the second adhesive portion 52 away from the non-adhesive region I has a certain distance away from the border of the flexible display panel 1, the connection position between the border of the second adhesive portion 52 close to the non-adhesive region I and the first adhesive portion 51 is chamfered, and the connection position between the border of the second adhesive portion 52 away from the non-adhesive region I and the first adhesive portion 51 is chamfered.

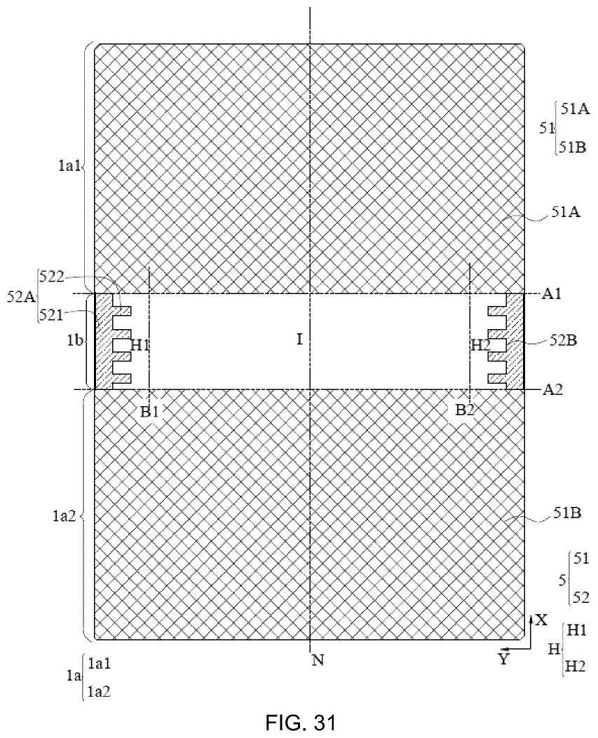

In another possible embodiment, as shown in FIG. 31, the second adhesive portion 52 includes a connection portion 521 and a plurality of protruding portions 522. In the first direction X, the connection portion 521 is connected to two first adhesive portions 51 located on two opposite sides of the connection portion 521. The plurality of protruding portions 522 are connected to the connection portion 521, and the plurality of protruding portions 522 are disposed on a side of the connection portion 521 close to the non-adhesive region I. The plurality of protruding portions 522 are arranged at intervals in the first direction X.

The connection portion 521 and the plurality of protruding portions 522 constitute the second adhesive portion 52, so as to realize the bonding between the support layer 4 and the second display portion 1b, thereby preventing the edge of the second display portion 1b from warping upward, and in turn improving the unsmooth light and shadow phenomenon of the flexible display panel 1. During the folding process of the foldable display module 10, since the plurality of protruding portions 522 are arranged at intervals, a gap between two adjacent protruding portions 522 may provide space for deformation of the second adhesive portion 52, so as to facilitate the folding of the foldable display module 10.

For example, the third adhesive sub-portion 52A includes a connection portion 521 and a plurality of protruding portions 522. And/or, the fourth adhesive sub-portion 52B includes a connection portion 521 and a plurality of protruding portions 522.

It will be understood that, in this case, the maximum size of the second adhesive portion 52 in the second direction Y refers to a sum of sizes of the connection portion 521 and the protruding portion 522 in the second direction Y.

The number of protruding portions 522 in one adhesive region H may be three, four, five, etc., which may be specifically set according to a size of the adhesive region H in the first direction X as well as a distance between two adjacent protruding portions 522.

In addition, protruding portions 522 in the two adhesive regions H may be equal in number. For example, the number of protruding portions 522 in each of the two adhesive regions H may be three or five. Alternatively, protruding portions 522 in the two adhesive regions H may be unequal in number. For example, the number of protruding portions 522 in one adhesive region H is three, and the number of protruding portions 522 in another adhesive region H is four.

For example, a distance between any two adjacent protruding portions 522 may be equal; alternatively, the distance between any two adjacent protruding portions 522 may be unequal.

For example, the connection portion 521 may be of a square-shaped structure, for example, may be in a shape of a rectangle or square. Since the connection portion 521 has a regular shape, the connection portion 521 may be easily arranged. Alternatively, the connection portion 521 may be of a parallelogram structure or an irregular curved structure.

Based on the above-mentioned structure that the second adhesive portion 52 includes a connection portion 521 and a plurality of protruding portions 522, in some embodiments, the connection portion 521 and the plurality of protruding portions 522 constitute a one-piece structure, and the connection portion 521 and the first adhesive portion 51 constitute a one-piece structure, so that the first adhesive portion 51 and the second adhesive portion 52 constitute a one-piece structure. In this way, the connection strength between the first adhesive portion 51, the connection portion 521 and the plurality of protruding portions 522 may be increased to increase the overall structural strength of the first adhesive portion 51, the connection portion 521 and the plurality of protruding portions 522, thereby more stably bonding the flexible display panel 1 to the support layer 4.

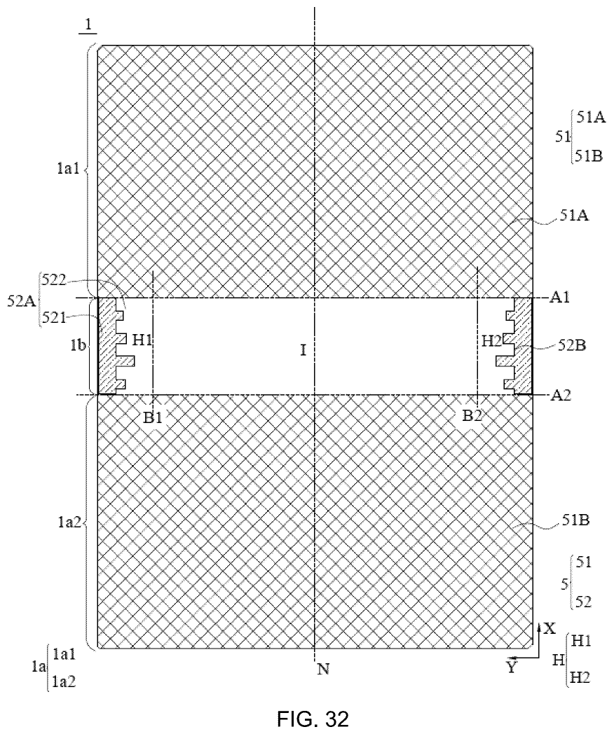

During the arrangement of the protruding portions 522, sizes of the plurality of protruding portions 522 in the second direction Y may be equal, thereby facilitating the arrangement of the plurality of protruding portions 522. Alternatively, the sizes of the plurality of protruding portions 522 in the second direction Y may be different. In the case where the sizes of the plurality of protruding portions 522 in the second direction Y are different, as shown in FIG. 32, in the first direction X, lengths of the plurality of protruding portions 522 first increase and then decrease. The length of the protruding portion 522 is the maximum size of the protruding portion 522 in the second direction Y.

In this way, borders of the plurality of protruding portions 522 close to the non-adhesive region I form a parabolic shape. Therefore, the plurality of protruding portions 522 match the state that the edge of the second display portion 1b warps upward in the simulation experiment as shown in FIG. 18, which may more purposefully fix the edge of the second display portion 1b and the support layer 4 to well ameliorate the degree of upward warping of the edge of the second display portion 1b.

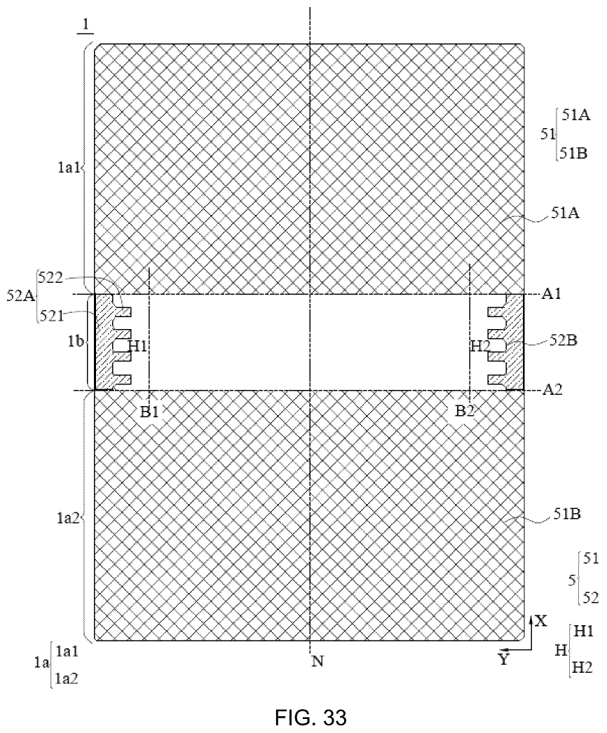

In some embodiments, as shown in FIG. 33, a connection position between the protruding portion 522 and the connection portion 521 is chamfered. In this way, when the adhesive layer 5 is formed through cutting, it facilitates the cutting and material discharge at the connection position between the protruding portion 522 and the connection portion 521. In addition, the chamfer structure may also reduce the requirements on the cutting tool and reduce the fabrication cost.

The connection position between the protruding portion 522 and the connection portion 521 is chamfered, which may have a rounded chamfer, and a radius of a rounded corner may be set according to actual needs. Alternatively, the connection position between the protruding portion 522 and the connection portion 521 may form an oblique chamfer, and an inclination of an oblique edge of the oblique chamfer may be 45° or 60°.

For example, connection positions between all the protruding portions 522 and the connection portion 521 form rounded chamfers. Alternatively, connection positions between all the protruding portions 522 and the connection portion 521 form oblique chamfers. Alternatively, connection positions between some of the plurality of protruding portions 522 and the connection portion 521 form rounded chamfers, and connection positions between some other of the plurality of protruding portions 522 and the connection portion 521 form oblique chamfers.

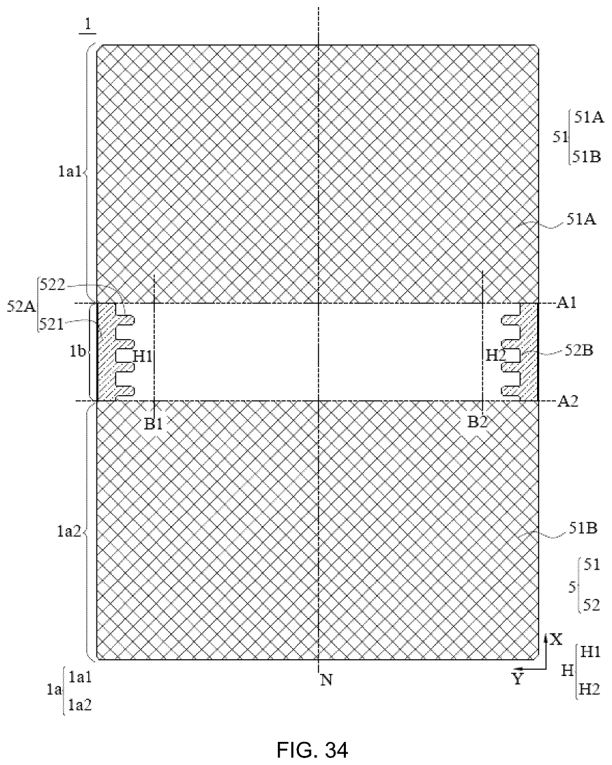

In some embodiments, as shown in FIG. 34, an end of the protruding portion 522 away from the connection portion 521 has a rounded corner. In this way, when the adhesive layer 5 is formed through cutting, it facilitates the cutting and material discharge at the end of the protruding portion 522 away from the connection portion 521. In addition, the rounded corner structure may also reduce the requirements on the cutting tool and reduce the fabrication cost.

It will be understood that the radius of the rounded corner will be reasonably set according to the size of the protruding portion 522 in the first direction X as well as requirements.

For example, ends, away from the connection portion 521, of some protruding portions 522 among the plurality of protruding portions 522 have rounded corners; and ends, away from the connection portion 521, of some other protruding portions 522 among the plurality of protruding portions 522 do not form rounded corners. Alternatively, ends, away from the connection portion 521, of all protruding portions 522 form rounded corners.

In actual products, the flexible display panel 1 needs to be not only supported, but also buffered as well as protected.

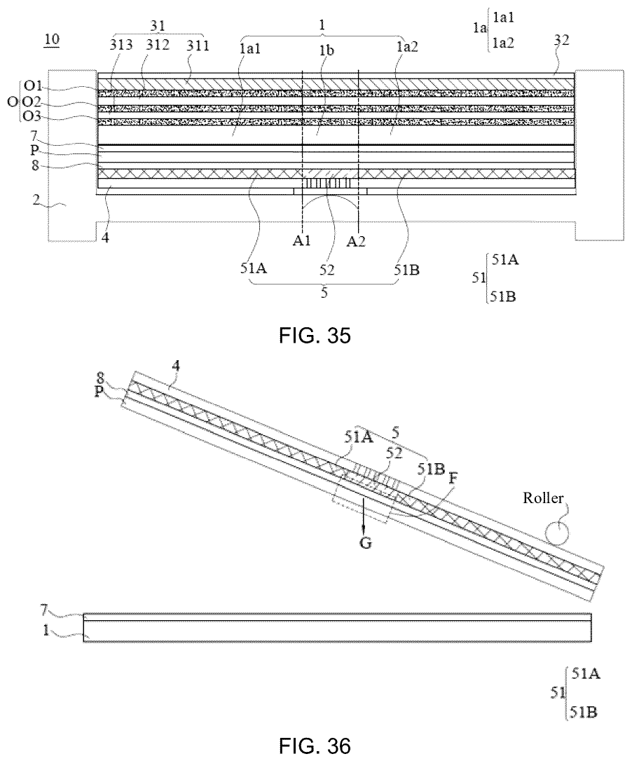

Based on this, in some embodiments, as shown in FIG. 35, the foldable display module 10 further includes a back film 7 (U-Film) and a buffer layer 8. The back film 7 is disposed between the flexible display panel 1 and the support layer 4. The buffer layer 8 is disposed between the back film 7 and the support layer 4. The adhesive layer 5 is located between the buffer layer 8 and the support layer 4. In this way, when the foldable display module 10 is impacted, the back film 7 and the buffer layer 8 can play a buffering role to reduce the force transmitted to the flexible display panel 1, thereby providing protection for the flexible display panel 1.

The back film 7 may be made of a transparent and flexible material. The material of the back film 7 includes but is not limited to PET, PI, etc. In this way, the back film 7 is bendable. When the foldable display module 10 is folded, the back film 7 can be folded along with the foldable display module 10.

For example, a thickness of the back film 7 is in a range of 50 μm to 100 μm. For example, the thickness of the back film 7 may be 50 μm, 60 μm, 63 μm, 65 μm, 68 μm, 70 μm, 80 μm or 100 μm. The thickness of the back film 7 within this range is relatively suitable, and it may be possible to provide sufficient support for the flexible display panel 1; in addition, it may also prevent the foldable display module 10 from being too thick as a whole, and in turn facilitate the light and thin design of the foldable display module 10.

For example, the thickness of the back film 7 is 65 μm. Thus, it may not only provide more sufficient support for the flexible display panel 1, but also be more conducive to the light and thin design of the foldable display module 10.

In some examples, the buffer layer 8 may be made of a flexible resin material which includes but is not limited to polyimide.

For example, the buffer layer 8 may be made of black polyimide, and the black buffer layer 8 may play a light-shielding role to prevent light emitted by the flexible display panel 1 from leaking from the backlight side of the flexible display panel 1.

For example, a thickness of the buffer layer 8 is in a range of 20 μm to 60 μm. For example, the thickness of the buffer layer 8 may be 20 μm, 30 μm, 40 μm, 50 μm or 60 μm.

Optionally, the thickness of the buffer layer 8 is in a range of 20 μm to 30 μm. For example, the thickness of the buffer layer 8 may be 20 μm, 23 μm, 25 μm, 27 μm or 30 μm. The thickness of the buffer layer 8 within this range is relatively suitable, and it may be possible to provide sufficient buffering for the flexible display panel 1; in addition, it may also prevent the foldable display module 10 from being too thick as a whole, and in turn facilitate the light and thin design of the foldable display module 10.

For example, the thickness of the buffer layer 8 is 25 μm. Thus, it may not only provide more sufficient buffering for the flexible display panel 1, but also be more conducive to the light and thin design of the foldable display module 10.

In some examples, as shown in FIG. 35, the foldable display module 10 further includes a fourth fixed sub-layer P disposed between the buffer layer 8 and the back film 7. The fourth fixed sub-layer P is used for bonding the buffer layer 8 and the back film 7 together, thus realizing a stable connection between the buffer layer 8 and the back film 7.

For example, a material of the fourth fixed sub-layer P may include pressure-sensitive adhesive. In this way, it may be possible to ensure that the fourth fixed sub-layer P has strong elasticity and is less prone to breakage, and a stable connection between the buffer layer 8 and the back film 7 can still be maintained after the foldable display module 10 is bent multiple times.

For example, a thickness of the fourth fixed sub-layer P is in a range of 15 μm to 25 μm. For example, the thickness of the fourth fixed sub-layer P may be 15 μm, 17 μm, 19 μm, 20 μm or 25 μm. The thickness of the fourth fixed sub-layer P within this range is relatively suitable, and it may be possible to stably connect the buffer layer 8 and the back film 7 together; in addition, it may also prevent the foldable display module 10 from being too thick as a whole, and in turn facilitate the light and thin design of the foldable display module 10.

For example, the thickness of the fourth fixed sub-layer P is 20 μm, so that the back film 7 and the buffer layer 8 may be connected together more stably, and it is also more conducive to the light and thin design of the foldable display module 10.

In some embodiments, when the film layers are attached using a roller process, as shown in FIG. 36, the back film 7 is first fixed to the backlight side (the upper side in FIG. 36) of the flexible display panel 1, and then the support layer 4, the buffer layer 8 and the fourth fixed sub-layer P are bonded together and flipped so that the fourth fixed sub-layer P faces the back film 7, and then the fourth fixed sub-layer P is bonded to the back film 7 using a roller process.

Since the second adhesive portion 52 is located between the support layer 4 and the buffer layer 8, the support layer 4 can provide support for a portion of the buffer layer 8 located in the F region in FIG. 36 and a portion of the fourth fixed sub-layer P located in the F region in FIG. 36. Thus, after flipping the support layer 4, the buffer layer 8 and the fourth fixed sub-layer P as a whole, due to the gravity G of the buffer layer 8 and the fourth fixed sub-layer P as a whole, the deformation degree of the fourth fixed sub-layer P is small or the fourth fixed sub-layer P does not deform. Thus, after the fourth fixed sub-layer P is bonded to the back film 7, the flatness of a bonding surface between the fourth fixed sub-layer P and the back film 7 may be improved. As a result, the unsmooth light and shadow phenomenon of the flexible display panel 1 is mitigated.

The root cause of upward warping of the edge of the second display portion 1b is the uneven force on the first substrate layer 31 in the protective layer 3. When the first HC layer 32 is cured, it will develop cohesive force that causes the edge of the first substrate layer 31 in the protective layer 3 to warp upward, and ultimately causes the edge of the entire protective layer 3 to warp upward. In this case, after the protective layer 3 is bonded to the flexible display panel 1, the edge of the second display portion 1b of the flexible display panel 1 will also warp upward due to the upward pulling force of the protective layer 3. Therefore, mitigating the edge warping degree of the protective layer 3 is of great significance for mitigating the edge warping problem of the flexible display panel 1.

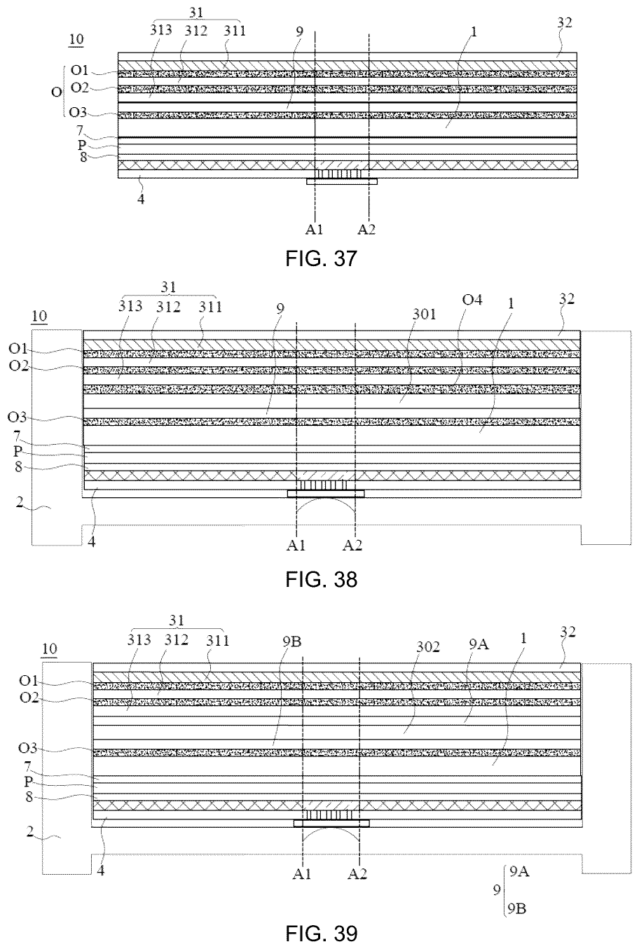

Based on this, in some embodiments, as shown in FIG. 37, the foldable display module 10 further includes at least one second HC layer 9 disposed between the first substrate layer 31 and the flexible display panel 1.

In this way, the second HC layer 9 and the first HC layer 32 will each develop cohesive force, and the first HC layer 32 and the second HC layer 9 are respectively located on two opposite surfaces of the first substrate layer 31; therefore, the second HC layer 9 may weaken or counteract the force of the first HC layer 32 acting on the first substrate layer 31. Thus, the protective layer 3 as a whole is relatively flat and straight. In this way, when the protective layer 3 and the second HC layer 9 are arranged on the flexible display panel 1, the upward pulling force on the flexible display panel 1 will be reduced or disappear, so that the upward warping degree of the edge of the flexible display panel 1 will also be reduced. As a result, the unsmooth light and shadow phenomenon of the flexible display panel 1 is mitigated.

It will be understood that the first HC layer 32 and the second HC layer 9 may be made of the same material or different materials.

For example, when the foldable display module 10 includes the third fixed sub-layer O3, the third fixed sub-layer O3 is disposed between the second HC layer 9 and the flexible display panel 1.

For example, there may be one, two or three second HC layers 9.

In some embodiments, as shown in FIG. 37, when there is one second HC layer 9, the second HC layer 9 may be directly disposed on a surface of the first substrate layer 31 away from the first HC layer 32.

In this case, in the actual manufacturing process, an upper surface of the first substrate layer 31 (a surface of the first substrate layer 31 away from the flexible display panel 1) is coated with the material of the first HC layer 32, and then a lower surface of the first substrate layer 31 (a surface of the first substrate layer 31 close to the flexible display panel 1) is coated with the material of the second HC layer 9. Then, the formed integrated product of the protective layer 3 and the second HC layer 9 is bonded to the light-exit side of the flexible display panel 1.

However, since coating the first substrate layer 31 with the material for forming the first HC layer 32 is earlier than coating the first substrate layer 31 with the material for forming the second HC layer 9, the first HC layer 32 will be cured first. In this case, during the coating process of the material for forming the second HC layer 9, the cohesive force of the second HC layer 9 may cause the already cured first HC layer 32 to break.

Based on this, after the coating process of the material for forming the first HC layer 32, the energy for curing the first HC layer 32 may be reduced to extend the curing time of the first HC layer 32, so that when coating the lower surface of the first substrate layer 31 with the material for forming the second HC layer 9, the first HC layer 32 has not been completely cured and the upward warping degree of the first substrate layer 31 is small, which avoids the breakage of the first HC layer 32 due to the second HC layer 9.

For example, the first HC layer 32 may be cured by heating. In this case, the curing time of the first HC layer 32 may be extended by reducing the curing temperature of the first HC layer 32.

For example, in this case, a thickness of the first substrate layer 31 is in a range of 50 μm to 70 μm. For example, the thickness of the first substrate layer 31 may be 50 μm, 55 μm, 60 μm, 65 μm or 70 μm. The thickness of the first substrate layer 31 within this range is relatively suitable, and it may be possible to provide sufficient protection for the flexible display panel 1; in addition, it may also prevent the foldable display module 10 from being too thick, and in turn facilitate the light and thin design of the foldable display module 10.

For example, the thickness of the first substrate layer 31 is 65 μm, and the first substrate layer 31 of such thickness may provide more sufficient protection for the flexible display panel 1. In addition, it is more conducive to the light and thin design of the foldable display module 10.

In the case where there is one second HC layer 9 disposed on the lower surface of the first substrate layer 31, the following experimental demonstration is carried out to obtain a more suitable thickness of the second HC layer 9. The following demonstration is introduced by taking an example in which the thickness of the first HC layer 32 is 5 μm and the thickness of the first substrate layer 31 is 65 μm. Please see Table 1 for details.

TABLE 1

| | Thickness of the second HC layer (μm) | | | | |
|---|---|---|---|---|---|
| | 1 | 2 | 3 | 4 | 5 |
| State of the | Upward | Flat | Slight | Downward | Downward |
| protective layer | warping | state | downward | warping | warping |
| and the second | state | | warping | state | state |
| HC layer as a | | | state | | |
| whole | | | | | |

It can be seen from Table 1 that when the thickness of the second HC layer 9 is 1 μm, the edges of the protective layer 3 and the second HC layer 9 as a whole are still in an upward warping state. When the thickness of the second HC layer 9 is 2 μm, the edges of the protective layer 3 and the second HC layer 9 as a whole are in a flat state. When the thickness of the second HC layer 9 is 3 μm, the edges of the protective layer 3 and the second HC layer 9 as a whole are in a slight downward warping state. When the thickness of the second HC layer 9 is greater than or equal to 4 μm and less than or equal to 5 μm, the edges of the protective layer 3 and the second HC layer 9 as a whole are in a downward warping state.

It can be seen from the above data that when the thickness of the second HC layer 9 is 2 μm, the protective layer 3 and the second HC layer 9 as a whole are in a flat state. After the protective layer 3 and the second HC layer 9 as a whole are attached to the flexible display panel 1, the edge upward warping of the flexible display panel 1 may be mitigated to a greatest extent, and the unsmooth light and shadow phenomenon of the flexible display panel 1 may be well improved.

It will be noted that the above experimental data in Table 1 is related to the material of the first substrate layer 31 as well as the state and manufacturing process of the first HC layer 32. Therefore, the control variate method needs to be used for verification during the experiment.

Based on the above experimental data, the thickness of the second HC layer 9 is less than the thickness of the first HC layer 32. In this way, the force of the first HC layer 32 acting on the first substrate layer 31 may be balanced, and the overall lightness and thinness of the foldable display module 10 may be guaranteed. Since the second HC layer 9 is disposed between the flexible display panel 1 and the first substrate layer 31 and is not located in a surface layer of the foldable display module 10, there is no need to use the second HC layer 9 to increase the structural strength of the surface of the flexible display panel 1. Therefore, even if the thickness of the second HC layer 9 is less than the thickness of the first HC layer 32, the structural strength of the surface of the foldable display module 10 will not be affected.

In some other embodiments, as shown in FIG. 38, when there is one second HC layer 9, the foldable display module 10 further includes a second substrate layer 301 disposed between the first substrate layer 31 and the second HC layer 9. By providing the second substrate layer 301, there are two substrate layers (the first substrate layer 31 and the second substrate layer 301) between the first HC layer 32 and the second HC layer 9. Therefore, it may be possible to increase the overall structural strength of the foldable display module 10 and improve the reliability of the foldable display module 10.

In this case, during the process of setting the second HC layer 9, the second substrate layer 301 may be fabricated first, and then the second substrate layer 301 is coated with the material of the second HC layer 9. After the second HC layer 9 is cured, the second substrate layer 301 is flipped such that the second substrate layer 301 is bonded to the first substrate layer 31. In this way, the second HC layer 9 is set. Since the fabricating process of setting the second HC layer 9 on the second substrate layer 301 is similar to the fabricating process of setting the first HC layer 32 on the first substrate layer 31, the difficulty of setting the second HC layer 9 may be reduced.

For example, when the surface of the foldable display module 10 is subjected to a pen drop test or a ball drop test, the second substrate layer 301 and the second HC layer 9 may increase the structural strength of the surface of the foldable display module 10 and prevent the surface of the flexible display panel 1 in the foldable display module 10 from being broken.

In some examples, as shown in FIG. 38, the foldable display module 10 further includes a fifth fixed sub-layer O4 disposed between the first substrate layer 31 and the second substrate layer 301, so as to bond the first substrate layer 31 and the second substrate layer 301 together.

For example, a material of the fifth fixed sub-layer O4 may include optically clear adhesive. A thickness of the fifth fixed sub-layer O4 may be set according to actual conditions.

In some examples, film layers included in the second substrate layer 301 may be the same as film layers (e.g., the transparent cover plate 312, the first sub-film 311, and the second sub-film 313) included in the first substrate layer 31.

For example, when the first substrate layer 31 includes the first sub-film 311, the transparent cover plate 312 and the second sub-film 313, the second substrate layer 301 also includes a first sub-film 311, a transparent cover plate 312, and a second sub-film 313.

For example, when the first substrate layer 31 includes the first sub-film 311 and the transparent cover plate 312, the second substrate layer 301 also includes a first sub-film 311 and a transparent cover plate 312.

For another example, when the first substrate layer 31 includes the transparent cover plate 312 and the second sub-film 313, the second substrate layer 301 also includes a transparent cover plate 312 and a second sub-film 313.

For another example, when the first substrate layer 31 includes the transparent cover plate 312, the second substrate layer 301 also includes a transparent cover plate 312.

In some other examples, the film layers included in the second substrate layer 301 may be different from the film layers included in the first substrate layer 31.

For example, the first substrate layer 31 includes the first sub-film 311, the transparent cover plate 312, and the second sub-film 313.

The second substrate layer 301 includes a first sub-film 311 and a second sub-film 313. Alternatively, the second substrate layer 301 includes a first sub-film 311. Alternatively, the second substrate layer 301 includes a second sub-film 313.

For another example, the first substrate layer 31 includes the first sub-film 311 and the transparent cover plate 312.

The second substrate layer 301 includes a first sub-film 311, a transparent cover plate 312 and a second sub-film 313. Alternatively, the second substrate layer 301 includes a first sub-film 311 and a second sub-film 313. Alternatively, the second substrate layer 301 includes a second sub-film 313 and a transparent cover plate 312. Alternatively, the second substrate layer 301 includes a transparent cover plate 312. Alternatively, the second substrate layer 301 includes a first sub-film 311. Alternatively, the second substrate layer 301 includes a second sub-film 313.

For another example, the first substrate layer 31 includes the transparent cover plate 312 and the second sub-film 313.

The second substrate layer 301 includes a first sub-film 311, a transparent cover plate 312 and a second sub-film 313. Alternatively, the second substrate layer 301 includes a first sub-film 311 and a second sub-film 313. Alternatively, the second substrate layer 301 includes a second sub-film 313. Alternatively, the second substrate layer 301 includes a transparent cover plate 312. Alternatively, the second substrate layer 301 includes a first sub-film 311.

For another example, the first substrate layer 31 includes the transparent cover plate 312.

The second substrate layer 301 includes a first sub-film 311, a transparent cover plate 312 and a second sub-film 313. Alternatively, the second substrate layer 301 includes a first sub-film 311 and a second sub-film 313. Alternatively, the second substrate layer 301 includes a second sub-film 313. Alternatively, the second substrate layer 301 includes a first sub-film 311.

For example, a thickness of the second substrate layer 301 is in a range of 20 μm to 60 μm. For example, the thickness of the second substrate layer 301 may be 20 μm, 25 μm, 30 μm, 40 μm, 50 μm or 60 μm. The thickness of the second substrate layer 301 within this range is relatively suitable, so that the arrangement of the second substrate layer 301 may be satisfied. In addition, it may also prevent the foldable display module 10 from being too thick as a whole, and in turn facilitate the light and thin design of the foldable display module 10.

In this case, referring to Table 2 below, two experiments are carried out to obtain a more suitable thickness of the second HC layer 9.

The first situation is introduced by taking an example in which the thickness of the first HC layer 32 is 5 μm, the thickness of the first substrate layer 31 is 65 μm, and the thickness of the second substrate layer is 25 μm for experimental demonstration.

The second situation is introduced by taking an example in which the thickness of the first HC layer 32 is 5 μm, the thickness of the first substrate layer 31 is 65 μm, and the thickness of the second substrate layer is 50 μm for experimental demonstration.

TABLE 2

| Second | | | | | |
|---|---|---|---|---|---|
| substrate | Second HC layer (μm) | | | | |
| layer (μm) | 1 | 2 | 3 | 4 | 5 |
| 25 | Upward | Slight | Flat | Slight | Downward |
| | warping | upward | state | downward | warping |
| | state | warping | | warping | state |
| | | state | | state | |
| 50 | Upward | Flat | Flat | Downward | Downward |
| | warping | state | state | warping | warping |
| | state | | | state | state |

It can be seen from Table 2 that, in the first situation, when the thickness of the second HC layer 9 is 1 μm, the edges of the protective layer 3, the second HC layer 9 and the second substrate layer 301 as a whole are still in an upward warping state. When the thickness of the second HC layer 9 is 2 μm, the edges of the protective layer 3, the second HC layer 9 and the second substrate layer 301 as a whole are in a slight upward warping state. When the thickness of the second HC layer 9 is 3 μm, the edges of the protective layer 3, the second HC layer 9 and the second substrate layer 301 as a whole are in a flat state. When the thickness of the second HC layer 9 is 4 μm, the edges of the protective layer 3, the second HC layer 9 and the second substrate layer 301 as a whole are in a slight downward warping state. When the thickness of the second HC layer 9 is 5 μm, the edges of the protective layer 3, the second HC layer 9 and the second substrate layer 301 as a whole are in a downward warping state.

It can be seen from the above data that, when the thickness of the second HC layer 9 is 3 μm, the protective layer 3, the second HC layer 9 and the second substrate layer 301 as a whole are in a flat state. After the protective layer 3, the second HC layer 9 and the second substrate layer 301 as a whole are attached to the flexible display panel 1, the protective layer 3, the second HC layer 9, the second substrate layer 301 and the flexible display panel 1 as a whole are in a flat state, thereby well mitigating the edge upward warping of the flexible display panel 1 and well mitigating the unsmooth light and shadow phenomenon of the flexible display panel 1.

It can be seen from Table 2 that, in the second situation, when the thickness of the second HC layer 9 is 1 μm, the edges of the protective layer 3, the second HC layer 9 and the second substrate layer 301 as a whole are still in an upward warping state. When the thickness of the second HC layer 9 is 2 μm, the edges of the protective layer 3, the second HC layer 9 and the second substrate layer 301 as a whole are in a flat state. When the thickness of the second HC layer 9 is 3 μm, the edges of the protective layer 3, the second HC layer 9 and the second substrate layer 301 as a whole are in a flat state. When the thickness of the second HC layer 9 is 4 μm, the edges of the protective layer 3, the second HC layer 9 and the second substrate layer 301 as a whole are in a downward warping state. When the thickness of the second HC layer 9 is 5 μm, the edges of the protective layer 3, the second HC layer 9 and the second substrate layer 301 as a whole are in a downward warping state.

It can be seen from the above data that when the thickness of the second HC layer 9 is in a range of 2 μm to 3 μm, the protective layer 3, the second HC layer 9 and the second substrate layer 301 as a whole are in a flat state. After the protective layer 3, the second HC layer 9 and the second substrate layer 301 as a whole are attached to the flexible display panel 1, the protective layer 3, the second HC layer 9, and the second substrate layer 301 as a whole and the flexible display panel 1 as a whole are in a flat state, thereby well mitigating the edge upward warping of the flexible display panel 1 and well mitigating the unsmooth light and shadow phenomenon of the flexible display panel 1.

It will be noted that the above experimental data in Table 2 is related to the material of the first substrate layer 31, the material of the second substrate layer 301, and the state and manufacturing process of the first HC layer 32. Therefore, the control variate method needs to be used for verification during the experiment.

Based on the above experimental data in Table 2, the thickness of the second HC layer 9 is less than the thickness of the first HC layer 32. In this way, the force of the first HC layer 32 acting on the first substrate layer 31 may be balanced, and the overall lightness and thinness of the foldable display module 10 may be guaranteed. Since the second HC layer 9 is disposed between the flexible display panel 1 and the first substrate layer 31 and is not located in a surface layer of the foldable display module 10, there is no need to use the second HC layer 9 to increase the structural strength of the surface of the flexible display panel 1. Therefore, even if the thickness of the second HC layer 9 is less than the thickness of the first HC layer 32, the structural strength of the surface of the foldable display module 10 will not be affected.

In addition, based on the above experimental data in Table 2, the thickness of the second substrate layer 301 is less than the thickness of the first substrate layer 31. Since the second substrate layer 301 is disposed between the flexible display panel 1 and the first substrate layer 31, the first substrate layer 31 mainly protects the flexible display panel 1. Therefore, the thickness of the second substrate layer 301 can be less than the thickness of the first substrate layer 31, which may facilitate the setting of the second HC layer 9 and facilitate the light and thin design of the entire foldable display module 10.

In some embodiments, as shown in FIG. 39, when there are a plurality of second HC layers 9, the foldable display module 10 further includes a third substrate layer 302 disposed between two adjacent second HC layers 9. By providing the plurality of second HC layers 9 and a plurality of third substrate layers 302, the force of the first HC layer 32 acting on the first substrate layer 31 is balanced, so that the flexible display panel 1 as a whole is in a relatively flat state, which mitigates the unsmooth light and shadow phenomenon of the flexible display panel 1.

In some examples, as shown in FIG. 39, there are two second HC layers 9, and the two second HC layers 9 are respectively a second HC sub-layer 9A and a second HC sub-layer 9B. The second HC sub-layer 9A is located on the second HC sub-layer 9B.

In some examples, film layers included in the third substrate layer 302 may be the same as film layers (e.g., the transparent cover plate 312 and the first sub-film 311) included in the first substrate layer 31. As for details, reference can be made to the examples of the first substrate layer 31 and the second substrate layer 301 as mentioned above. Only some of the examples will be introduced below, which will not be described in detail.

For example, when the first substrate layer 31 includes the first sub-film 311, the transparent cover plate 312, and the second sub-film 313, the third substrate layer 302 also includes a first sub-film 311, a transparent cover plate 312, and a second sub-film 313.

For another example, when the first substrate layer 31 includes the transparent cover plate 312 and the second sub-film 313, the third substrate layer 302 also includes a transparent cover plate 312 and a second sub-film 313.

In some other examples, the film layers included in the third substrate layer 302 may be different from the film layers included in the first substrate layer 31.

For example, when the first substrate layer 31 includes the first sub-film 311, the transparent cover plate 312, and the second sub-film 313.

The third substrate layer 302 includes a first sub-film 311 and a second sub-film 313. Alternatively, the third substrate layer 302 includes a first sub-film 311. Alternatively, the third substrate layer 302 includes a second sub-film 313.

For another example, the first substrate layer 31 includes the first sub-film 311 and the transparent cover plate 312.

The third substrate layer 302 includes a first sub-film 311, a transparent cover plate 312, and a second sub-film 313. Alternatively, the third substrate layer 302 includes a first sub-film 311 and a second sub-film 313. Alternatively, the third substrate layer 302 includes a second sub-film 313 and a transparent cover plate 312. Alternatively, the third substrate layer 302 includes a transparent cover plate 312. Alternatively, the third substrate layer 302 includes a first sub-film 311. Alternatively, the third substrate layer 302 includes a second sub-film 313.

In some embodiments, a thickness of the third substrate layer 302 is less than the thickness of the first substrate layer 31. Since the third substrate layer 302 is disposed between the flexible display panel 1 and the first substrate layer 31, the first substrate layer 31 mainly protects the flexible display panel 1. Therefore, the thickness of the third substrate layer 302 can be less than the thickness of the first substrate layer 31, which may facilitate the setting of the second HC layer 9 and facilitate the light and thin design of the foldable display module 10.

The foregoing descriptions are merely specific implementation manners of the present disclosure, but the protection scope of the present disclosure is not limited thereto, any changes or replacements that a person skilled in the art could conceive of within the technical scope of the present disclosure shall be included in the protection scope of the present disclosure. Therefore, the protection scope of the present disclosure shall be subject to the protection scope of the claims.

1. A foldable display module, comprising:
a support layer;
an adhesive layer located on the support layer;
a flexible display panel located on the adhesive layer, wherein the flexible display panel includes a plurality of first display portions and at least one second display portion, the plurality of first display portions are sequentially arranged in a first direction, and a second display portion of the at least one second display portion is located between two adjacent first display portions; the second display portion is bendable, and a bending axis is along a second direction;
the second display portion has a non-adhesive region and adhesive regions that are located on two opposite sides of the non-adhesive region in the second direction, the first direction being perpendicular to the second direction; and
a protective layer located on the flexible display panel;
wherein the adhesive layer includes a plurality of first adhesive portions and a plurality of second adhesive portions, a first adhesive portion is disposed between a first display portion and the support layer, and at least one second adhesive portion is disposed in an adhesive region.

2. The foldable display module according to claim 1, wherein the second adhesive portion is in a shape of a strip; and in the first direction, the second adhesive portion is connected to two first adhesive portions located on two opposite sides of the second adhesive portion.

3. The foldable display module according to claim 2, wherein a border of the second adhesive portion close to the non-adhesive region is curved, and protrudes toward a direction close to the non-adhesive region.

4. The foldable display module according to claim 2, wherein a connection position between the second adhesive portion and a first adhesive portion of the two first adhesive portions is chamfered.

5. The foldable display module according to claim 1, wherein the second adhesive portion includes:
a connection portion, wherein in the first direction, the connection portion is connected to two first adhesive portions located on two opposite sides of the connection portion; and
a plurality of protruding portions connected to the connection portion and being disposed on a side of the connection portion close to the non-adhesive region, the plurality of protruding portions being arranged at intervals in the first direction.

6. The foldable display module according to claim 5, wherein in the first direction, lengths of the plurality of protruding portions first increase and then decrease; and
a length of a protruding portion is a maximum size of the protruding portion in the second direction.

7. The foldable display module according to claim 5, wherein a connection position between a protruding portion and the connection portion is chamfered.

8. The foldable display module according to claim 5, wherein an end of a protruding portion away from the connection portion has a rounded corner.

9. The foldable display module according to claim 1, wherein in the second direction, a maximum size of the second adhesive portion is in a range of 5 mm to 10 mm.

10. The foldable display module according to claim 1, wherein the non-adhesive region has a center line along the first direction;
second adhesive portions in two adhesive regions are symmetrically arranged about the center line.

11. The foldable display module according to claim 1, wherein the support layer is provided therein with a plurality of through holes, and orthogonal projections of the plurality of through holes on the second display portion are located within the non-adhesive region.

12. The foldable display module according to claim 2, wherein the two first adhesive portions and the second adhesive portion constitute a one-piece structure.

13. The foldable display module according to claim 1, wherein the protective layer includes:
a first substrate layer located on the flexible display panel; and
a first hard coating layer disposed on a side of the first substrate layer away from the flexible display panel;
the foldable display module further comprises: at least one second hard coating layer disposed between the first substrate layer and the flexible display panel.

14. The foldable display module according to claim 13, wherein the at least one second hard coating layer includes one second hard coating layer, and the foldable display module further comprises a second substrate layer disposed between the first substrate layer and the second hard coating layer.

15. The foldable display module according to claim 14, wherein a thickness of the second substrate layer is less than a thickness of the first substrate layer.

16. The foldable display module according to claim 13, wherein the at least one second hard coating layer includes a plurality of second hard coating layers, and the foldable display module further comprises: a third substrate layer disposed between two adjacent second hard coating layers.

17. The foldable display module according to claim 1, wherein a thickness of the second hard coating layer is less than a thickness of the first hard coating layer.

18. A foldable display apparatus, comprising:
a foldable display module which is the foldable display module according to claim 1; and
a middle frame disposed on a non-light-exit side of the foldable display module.

19. The foldable display module according to claim 5, wherein the non-adhesive region has a center line along the first direction;
second adhesive portions in two adhesive regions are symmetrically arranged about the center line.

20. The foldable display module according to claim 5, wherein the protective layer includes:
a first substrate layer located on the flexible display panel; and
a first hard coating layer disposed on a side of the first substrate layer away from the flexible display panel;
the foldable display module further comprises: at least one second hard coating layer disposed between the first substrate layer and the flexible display panel.
